(19) United States
(12) Patent Application Publication
(10) Pub. No.: US 2012/0221669 A1
(43) Pub. Date: Aug. 30, 2012

(54) COMMUNICATION METHOD FOR PARALLEL COMPUTING, INFORMATION PROCESSING APPARATUS AND COMPUTER READABLE RECORDING MEDIUM

(75) Inventor: Tsuyoshi HASHIMOTO, Kawasaki (JP)

(73) Assignee: FUJITSU LIMITED, Kawasaki-shi (JP)

(21) Appl. No.: 13/467,347

(22) Filed: May 9, 2012

Related U.S. Application Data
(63) Continuation of application No. PCT/JP2009/069301, filed on Nov. 12, 2009.

(51) Int. Cl. G06F 15/16; G06F 15/167

(52) U.S. Cl. 709/212; 709/248

(57) ABSTRACT

A communication method includes reporting information that indicates disposition of communication data in a communication buffer from a first node to second nodes by a multi-destination delivery using a barrier synchronization or a reduction to all nodes. The communication data is transferred between the first node and the second nodes by at least one of collective communication methods as a node-to-node communication method used in parallel computing. The communication method transfers the communication data by the second nodes using the information that indicates the disposition of the communication data in the communication buffer.

### CROSS-REFERENCE TO RELATED APPLICATIONS

This application is a continuation application filed under 35 U.S.C. 111(a) claiming benefit under 35 U.S.C. 120 and 365(c) of a PCT International Application No. PCT/JP2009/069301, filed on Nov. 12, 2009, the entire contents of which are incorporated herein by reference.

### FIELD

The disclosure relates to a communication method for parallel computing, an information processing apparatus, and a computer readable recording medium.

### BACKGROUND

A technique is known in which, in an apparatus that carries out collective communication using a parallel computing system, a communication time is reduced by reducing data transfer using a communication path that is relatively low in speed compared to parts such as a processor or a memory.

The collective communication may include multi-destination delivery, “barrier synchronization”, “gather”, “gather to all nodes”, “scatter”, “reduction”, “reduction to all nodes”, and “all-to-all communication”.

The multi-destination delivery (or broadcast communication) is a communication method of transmitting the same message to a plurality of destinations simultaneously. The barrier synchronization is a synchronization method of completing synchronization by carrying out calling of a function provided for synchronization at all nodes that participate in the synchronization. The scatter is a collective communication that transmits data simultaneously to a plurality of nodes from a node that acts as a transmission origin, similarly to the multi-destination delivery, and allows the data to differs for each of the transmission destinations. The gather is a collective communication of collecting data simultaneously from a plurality of nodes to a certain single reception-side node, and transfers the data in a direction opposite to that of the scatter. The reduction is a communication method in which an operation target data or value is transmitted from the nodes to a reduction apparatus, and the nodes receive an operation result from the reduction apparatus.

A technique is known in which a type of collective communication is realized by combining other types of collective communication. For example, the “gather to all nodes” or the “reduction to all nodes” can be realized by combining “gather at a single node” or “reduction at a single node” and the “multi-destination delivery from the single node to all the other nodes”.

### SUMMARY

It is one object in one embodiment to provide a configuration by which a high performance may be realized using limited communication resources when collective communication methods are used as node-to-node communication methods in parallel computing.

According to one aspect of an embodiment, a communication method for parallel computing may include reporting information that indicates disposition of communication data in a communication buffer by a first node to a plurality of second nodes by a multi-destination delivery using a barrier synchronization or a reduction to all nodes, the communication data being transferred between the first node and the plurality of second nodes by at least one of a plurality of collective communication methods as a node-to-node communication method used in parallel computing; and transferring the communication data between the first node and the plurality of second nodes by the plurality of second nodes using the information that indicates the disposition of the communication data in the communication buffer.

The object and advantages of the invention will be realized and attained by means of the elements and combinations particularly pointed out in the claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram illustrating sharing of a communication resource by one-to-one communication and collective communication in parallel computing, according to a communication method for parallel computing in an embodiment of the present invention;

FIG. 2 is a block diagram illustrating adding a function common to collective communication to a network, according to a communication method for parallel computing in an embodiment of the present invention;

FIG. 3 is a block diagram illustrating an example of providing a communication buffer in a communication device, according to a communication method for parallel computing in an embodiment of the present invention;

FIGS. 4A, 4B, 5A and 5B are operation flowcharts illustrating methods of realizing a reliable multi-destination delivery method to be used in collective communication, according to a communication method for parallel computing in an embodiment of the present invention;

FIGS. 6A, 6B and 6C illustrate a flow of operations in the method of FIGS. 4A and 4B;

FIGS. 7A, 7B and 7C illustrate a flow of operations in the method of FIGS. 5A and 5B;

FIG. 8 is a block diagram illustrating an example of carrying out collective communication using different types of networks, according to a communication method for parallel computing in an embodiment of the present invention;

FIGS. 9A and 9B are flowcharts illustrating a flow of operations for carrying out collective communication (scatter), according to a communication method for parallel computing in an embodiment of the present invention;

FIG. 9C is a flowchart illustrating an example in which multi-destination delivery reliable for short data is realized by combining not-necessarily reliable multi-destination delivery and reliable one-to-one communication;

FIGS. 10A, 10B and 10C illustrate a flow of operations in the method of FIGS. 9A and 9B;

FIGS. 11A and 11B are flowcharts illustrating a flow of operations for barrier synchronization when carrying out collective communication (scatter), according to a communication method for parallel computing in an embodiment of the present invention;

FIGS. 12A and 12B are flowcharts illustrating a flow of operations for carrying out collective communication (gather), according to a communication method for parallel computing in an embodiment of the present invention;

FIGS. 13A and 13B illustrate a flow of operations in the method of FIGS. 12A and 12B;

FIG. 14 is a block diagram illustrating a hardware configuration example of each of the nodes (transmission-side nodes, reception-side nodes and relay nodes);

FIG. 15 is a flowchart depicting a flow of operations of multi-destination delivery using barrier synchronization;

FIG. 16 is a flowchart depicting a flow of operations of barrier synchronization depicted in FIG. 15;

FIG. 17 is a flowchart depicting a flow of operations of multi-destination delivery (in a method using a reduction apparatus) according to an embodiment of the present invention;

FIG. 18 is a flowchart depicting a flow of operations of multi-destination delivery using the reduction apparatus described in FIG. 17;

FIG. 19 is a block diagram illustrating multi-destination delivery using the reduction apparatus described in FIGS. 17 and 18;

FIG. 20 illustrates an example of setting a communication buffer; and

FIG. 21 illustrates an example of a data format of recovery information.

### DESCRIPTION OF EMBODIMENTS

A communication method for parallel computing may be used when a node-to-node communication is carried out in parallel computing in order to obtain operation results as a result of a plurality of nodes carrying out data processing operations in parallel (hereinafter simply referred to as “parallel computing”). A communication method for parallel computing according to an embodiment of the present invention includes at least one of the following communication methods (1) through (5) for collective communication.

(1) In the method (1), communication resources described below are used in a plurality of types of collective communication including “scatter” and “gather” as the node-to-node communication in parallel computing. Hereinafter, “scatter” and “gather” as the node-to-node communication in parallel computing may simply be referred to as “scatter” and “gather”, respectively. That is, communication resources used in the one-to-one communication (or peer-to-peer communication) that is a node-to-node communication are used also in collective communication. Further, data communication paths used when the one-to-one communication is carried out is used also when increasing the speed of the collective communication. Further, communication resources including communication devices, communication cables and communication relay apparatuses at the nodes that carry out parallel computing may be used also in the collective communication. The communication devices may be, for example, communication cards, and the communication cards may be, for example, network interface cards (NICs).

(2) In the method (2), the following communication method is used as an effective and simple communication method that may be used in common to the plurality of types of collective communication including “scatter” and “gather”. At least one of a “multi-destination delivery method reliable for (relatively) short data”, “a buffer that exits in a communication device and operable by software of a node” and “a method of waiting for a plurality of items of data in parallel in a communication device” is used.

A definition of “short (data)” in the above-mentioned “multi-destination delivery method reliable for (relatively) short data” will now be described. The term “short” may only mean that “data that may be transmitted by one operation of multi-destination delivery is shorter than data that is to be transmitted by the multi-destination delivery in parallel computing”. Significance of “short (data)” will be further described. Generally, the more the functions of a transmission method are limited, the easier the transmission method may be implemented as hardware. Examples of “short data” may include, for example, “a message shorter than a physical packet length at one time”, data including only a header part having a fixed length without a message body having a variable length, such as a control packet, and the like. Here, a multi-destination delivery function having a constraint of “communication target data being limited to a message shorter than a physical packet length of one time”, or a constraint of “communication target data including only a header part having a fixed length without a message body having a variable length” will be assumed. The multi-destination delivery function having such a constraint is significant in that it is easier to realize than a more common multi-destination delivery function provided for “data including a message body including a plurality of packets” (i.e., data other than “short data”).

The above-mentioned “multi-destination delivery method reliable for (relatively) short data”, “buffer that exists in a communication device and operable by software of a node” or “method of waiting for the plurality of items of data in parallel in a communication device” may be used for increasing the speed of the collective communication.

(3) In the method (3), “reliable one-to-one communication” and “not necessarily reliable multi-destination delivery” are combined, and a “reliable multi-destination delivery method” is created. Then, the “reliable multi-destination delivery method” is used for realizing the collective communication including “scatter” and “gather” or for increasing the speed of the collective communication.

The “reliable communication” (such as “reliable one-to-one communication” or the “reliable multi-destination delivery”) refer to a communication for which when the communication procedure is completed, it is guaranteed that data properly arrives at the other side. “Not necessarily reliable communication” (such as the “not necessarily reliable multi-destination delivery”) refer to a communication for which when the communication procedure is completed, there is no guarantee that data properly arrives at the other side. One example of the “not necessarily reliable communication” may be a communication by multicast. The multicast is a communication method in which, in a network, a plurality of destinations are designated, and the same data is transmitted the destinations. Usually, in this method, when the communication procedure is completed, there is no guarantee that data properly arrives at the destinations. Therefore, the multicast may be categorized as being the “not necessarily reliable communication”.

(4) In the method (4), at least one of the above-mentioned methods (1), (2) and (3) is combined with a Remote Direct Memory Access (RDMA) function, and the combination is used for realizing the collective communication including “scatter” and “gather” or for increasing the speed of the collective communication.

(5) In the method (5), when carrying out at least one of the above-mentioned methods (1), (2), (3) and (4), a plurality of communication networks included in the communication networks of a system are used in a sharing manner. Then, the plurality of communication networks are used for realizing the collective communication including “scatter” and “gather” or for increasing the speed of the collective communication.

That is, a communication method for parallel computing according to an embodiment of the present invention may be used when carrying out the collective communication as node-to-node communication in a system that carries out parallel computing.

The transmission methods for collective communication in a parallel computing system may be generally classified into the following three methods 1), 2) and 3).

1) As a first realization example, the collective communication is realized when each of the nodes carries out the data transfer between the nodes using a reliable one-to-one communication according to a certain algorithm. In this method, a communication network provided for the collective communication or the mechanism provided for increasing the speed of the collective communication is not used, but a communication network provided for the common one-to-one communication is used instead in order to carry out the collective communication. Therefore, this method is advantageous in that the cost for the realization is low. The above-mentioned “mechanism provided for increasing the speed of collective communication” may be an apparatus or the like provided only for the collective communication. As a technique related to this method, a selection of a relay algorithm exists. Further, technique exist for improving the speed of the one-to-one communication in each relay stage, using characteristics of the transmission method of the system. These techniques have certain advantageous effects for reducing a transfer time by reducing the number of times of the transfer operations are carried out. However, these techniques may have the following limits.

For transmitting the same data to the plurality of nodes or waiting for data from the plurality of nodes, a processing time elapses in proportion to the number of nodes. Therefore, a relay operation is carried out in order to make the communication with many nodes, and the number of times the relay operation is carried out increases on the order of the logarithm (base: 2) of the number of nodes.

When the relay operation is carried out, the data enters a node via a network interface, and after that, the data exits from the node via the network interface. Therefore, a communication delay occurs by an amount corresponding to two times the time required to pass through the network interfaces per one relay operation.

The bandwidth of the communication including the relay operation is also limited by the bandwidths of the network interface.

2) As a second realization example, a method exists in which, in a communication path used for the one-to-one communication, a function of carrying out a specific collective communication is incorporated. As a typical example, a system exists in which the multi-destination delivery reliable for a common data length and the collective communication (“gather”) of collecting data from other nodes (having data transfer directions opposite to those of multi-destination delivery) are incorporated. The above-mentioned “common data length” means, for example, any packet size that is supported by a communication device. In principle, the effectiveness of the incorporated collective communication for increasing the speed is high. However, the realization cost may increase from the view point of the amount of the resources used because of the increase in the scale of the circuit. The reason why the effectiveness of the incorporated collective communication for increasing the speed is high is that hardware provided exclusively for the collective communication is required. In consideration of the constraint due to the amount of resources, in many cases, a constraint of “addresses of belonging nodes meeting a specific requirement (for example, “all the addresses are consecutive numbers)” or the like may be imposed on the collection of nodes that may carry out the multi-destination delivery and/or the “gather” by hardware.

3) As a third realization example, a method exists in which dedicated networks are prepared for the plurality of types of collective communication. As a typical example, the dedicated communication networks are prepared for each of the barrier synchronization process and the reduction process. Further, a system may be provided in which the above-mentioned method 2) is also used together, and in the communication path used for the one-to-one communication, the multi-destination delivery method reliable for the common data length is incorporated. Effectiveness of this system for increasing the speed of the collective communication is theoretically high. However, the number of parts in the entire system may increase, and thereby, the constraint imposed on the amount of resources may be more severe from the view point of the circuit scales of the respective parts. Since the conditions for achieving the performances of the respective parts are thus limited, the specific methods of operating the entire system for achieving the performance may be limited.

When increasing the performance of “collective communication” that is the communication to be carried out cooperatively by the plurality of nodes in parallel computing, it may be advantageous to use a wiring connection (topology), a transmission method having a special configuration and/or a speed increasing mechanism suitable for a communication pattern unique to the particular type of collective communication. The speed increasing mechanism refers to a dedicated apparatus unique to the particular type of collective communication. On the other hand, when creating the parallel computing system including many nodes, the constraint may be large on the amount of resources for specific elements of the network. The dominant limitation on the parts depends on the structure of the system and/or the characteristics of the communication medium. As typical examples, the limitations concerning the number of the communication interfaces, the total number of the communication cables and the communication devices per node, the circuit scales of the respective parts, and the like, may be considered. In consideration of these limitations, a configuration may be employed such that the collective communication is carried out using a combination of one-to-one communication operations instead of creating a network exclusively for the collective communication or installing a speed increasing mechanism for the respective types of collective communication. According to a communication method for parallel computing in an embodiment of the present invention, high-performance collective communication in parallel computing may be realized by a network provided for the collective communication in which the increase in the amount of the elements of the network may be reduced.

A communication method for parallel computing according to an embodiment of the present invention may use, as mentioned above, at least one of the following methods (1), (2), (3), (4) and (5).

(1) In communication paths or speed increasing mechanisms common to various types of collective communication including “scatter” and “gather”, data communication paths of one-to-one communication and a communication mechanism, which includes communication interfaces in nodes that carry out parallel computing, communication cables and communication relay apparatuses, are used. Thus, the realization costs are reduced in the entirety of the network.

(2) The following configurations (i), (ii) and (iii) may be used as mechanisms that are effective and simple in common to the plurality of types of collective communication including “scatter” and “gather”. That is, (i) the “multi-destination delivery method reliable for (relatively) short data”, (ii) the “buffer that exists in a communication device and operable by software of a node that carries out parallel computing” and (iii) the “method of waiting for the plurality of items of data in parallel in a communication device” may be used. As a specific method of use, one of these configurations (i), (ii) and (iii) may be used, or a combination of a plurality of configurations thereof may be used. Specific examples will be described later. Thus, by providing the configuration(s) common to the plurality of types of collective communication, an increase in the circuit scale may be reduced, which may otherwise occur in a case where communication paths and/or speed increasing mechanisms are provided exclusively for the respective types of collective communication.

(3) In a case where a transmission method that does not have the above-mentioned “multi-destination delivery reliable for (relatively) short data” is used, “reliable multi-destination delivery” may be realized by combining “reliable one-to-one communication” and “not necessarily reliable multi-destination delivery”. Then, the “reliable multi-designation delivery” may be used for increasing the speed of collective communication including “scatter” and “gather”.

(4) At least one of the above-mentioned methods (1), (2) and (3) may be combined with the RDMA function, and in order to carry out respective types of collective communication including “scatter” and “gather”.

(5) When one or a plurality of methods amongst the above-mentioned methods (1), (2), (3) and (4) is(are) carried out, the plurality of networks included in the network system may be used.

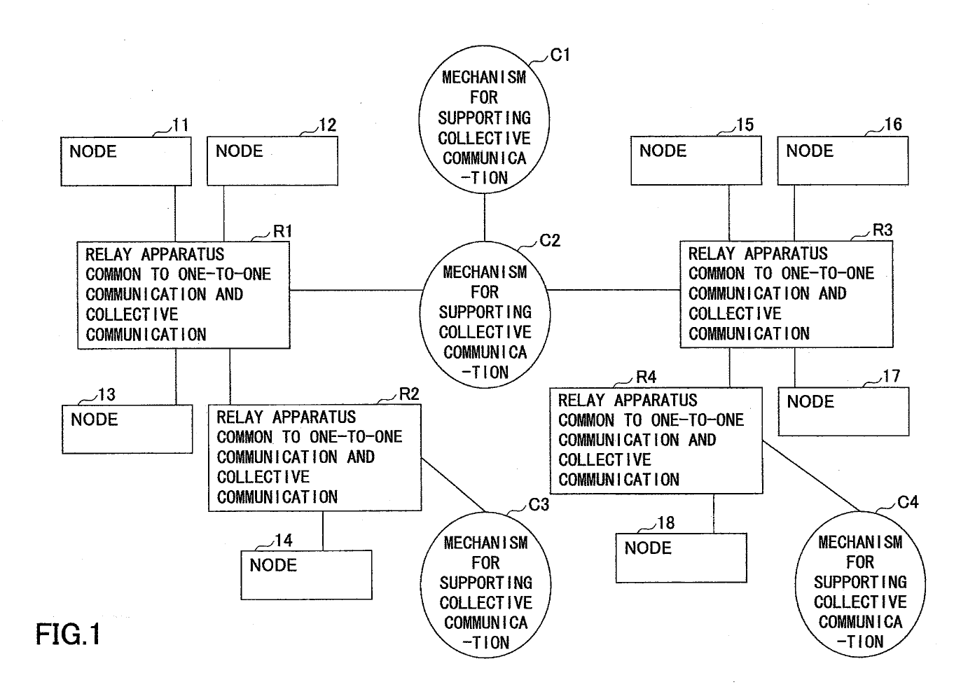

FIG. 1 is a block diagram schematically depicting an example of using a mechanism for collective communication, applicable to a communication method for parallel computing according to an embodiment of the present invention. FIG. 1 depicts a realization example of the above-mentioned method (1).

In FIG. 1, nodes 11, 12, 13, 14, 15, 16, 17 and 18 carry out parallel computing. Further, communication relay apparatuses R1, R2, R3 and R4 in FIG. 1 may be used in a common to one-to-one communication and a collective communication. The communication relay apparatuses may be the so-called switches or routers. The nodes 11 through 18 use, also for the purpose of collective communication, the communication relay apparatuses R1 through R4, each of which is used for the one-to-one communication. Thus, the amount of the communication resources used in the entire system may be effectively reduced. The above-mentioned one-to-one communication may be, for example, a communication that uses Transmission Control Protocol/Internet Protocol (TCP/IP), a communication that uses the RDMA function, or the like.

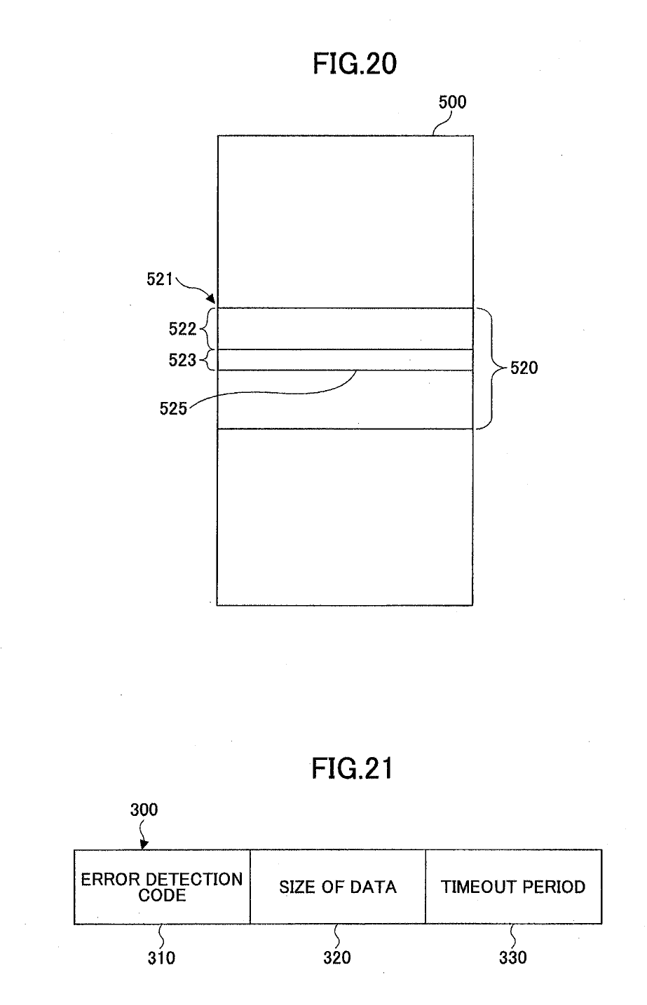

In the following description, “buffers” may be storage units in a network from which all the other nodes in the network may obtain transmission data or communication data using the RDMA function by designating pairs of addresses of the storage units in the network and addresses in the storage units. For example, storage units at locations such as locations (p), (q) and (r) described below may be used as the buffers (communication buffers or the like). Further, a plurality of locations such as the locations (p), (q) and (q) may be used together. A specific example of the buffer (communication buffer or the like) will be described later using FIG. 20.

(p) A memory located in a transmission-side node itself or a memory located in a communication card of a transmission-side node.

(p) A memory located in a communication relay apparatus itself or a memory located in a communication card of a communication relay apparatus.

(r) A storage unit located in a network (a memory in a communication relay apparatus or a memory that works with a communication relay apparatus).

An influence due to a difference in the specific implementation position (location) of the memory used as the buffer (communication buffer or the like) is limited to a range of the following points (a) through (d).

(a) A difference in “the location of the transmission data in the network (the pair of the address of the storage unit in the network and the address in the storage unit)” when carrying out the RDMA function used in a communication procedure.

(b) A difference in a command (or a sequence of commands) used for starting the RDMA function.

(c) A difference in a communication delay depending on the position of implementation of the buffer (for example, in a case where a memory in a NIC, a communication device in a communication relay apparatus, or the like is used, a delay time generated when the transmission data is sent out to the network is, generally, smaller in comparison to a case where the memory (main storage) of the transmission-side node is used).

(d) A difference in a capacity depending on the position of implementation of the buffer (generally, the capacity of the memory in the communication device is smaller than the capacity of the main storage of the transmission-side node).

For the sake of convenience of explanation, the memories of the above-mentioned items (p), (q) and (r) are not distinguished from each other, and will be simply referred to as “buffers” (“communication buffers” or the like).

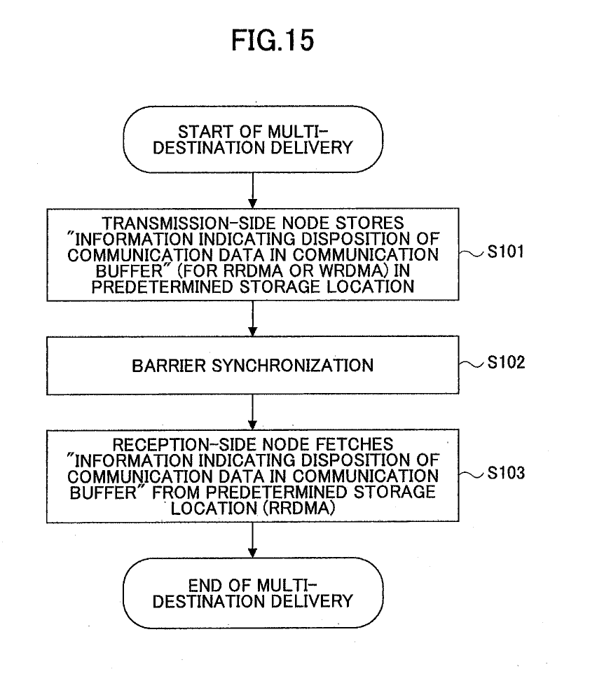

Mechanisms C1, C2, C3 and C4 for the collective communication in FIG. 1 may include, for example, circuits or apparatuses which realize a “barrier synchronization” or a “reduction”, described later using FIGS. 15 through 19, “buffers” (“communication buffers” or the like) for storing “transmission data” (“communication data”), or the like. Further, the mechanisms for collective communication may include a mechanism that carries out (i) the “multi-destination delivery method reliable for (relatively) short data” or (ii) the “buffer that exists in a communication device and operable by software of a node that carries out parallel computing” in the above-mentioned method (2). The mechanisms for collective communication may include (iii) the “mechanism of waiting for the plurality of items of data in parallel in a communication device” in the above-mentioned method (2). The mechanisms for collective communication may include a mechanism that carries out “reliable multi-destination delivery” obtained by combining “reliable one-to-one communication” and “not necessarily reliable multi-destination delivery” in the above-mentioned method (3). The mechanisms for collective communication may include a mechanism that carries out the RDMA function in the above-mentioned method (4), or the plurality of networks in the above-mentioned method (5).

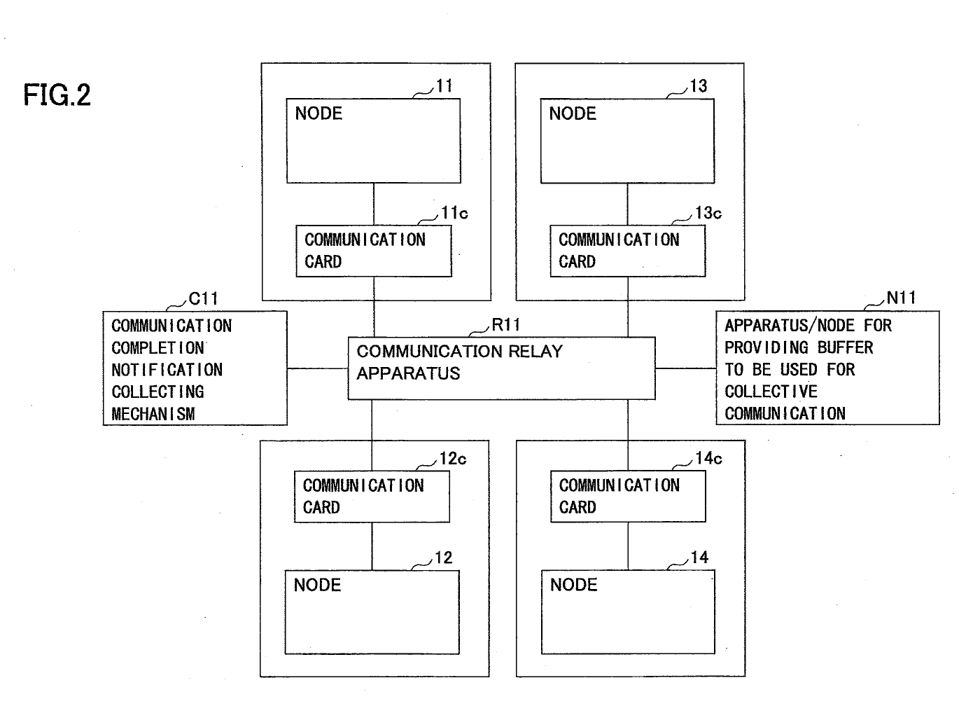

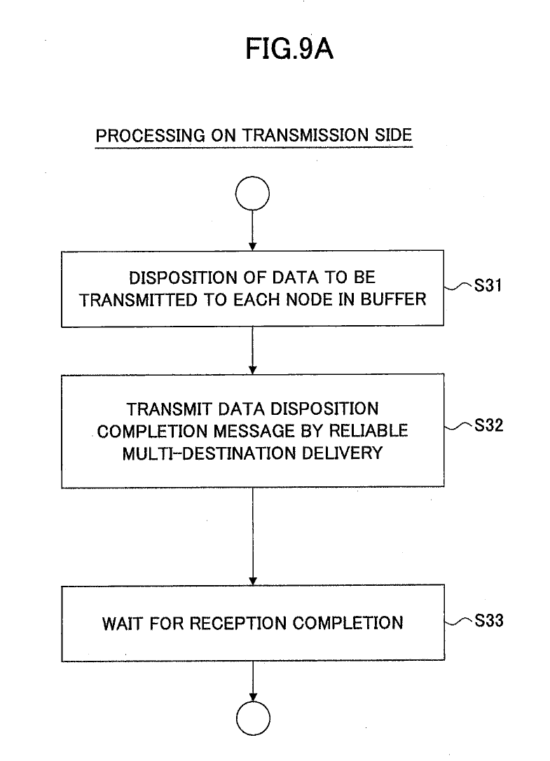

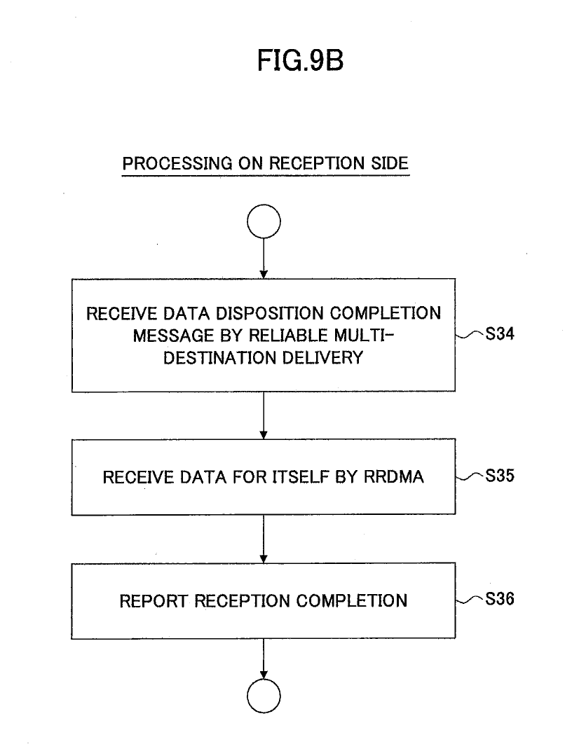

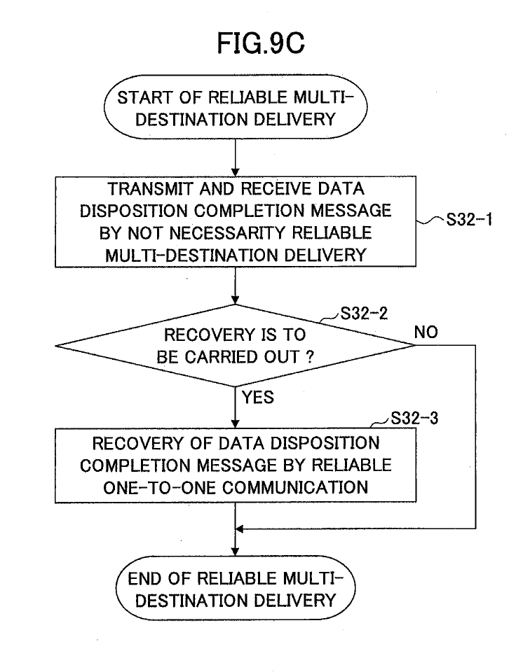

FIG. 2 is a block diagram schematically illustrating a realization example of the above-mentioned method (2). In FIG. 2, nodes 11, 12, 13 and 14 carry out parallel computing, and have communication cards (for example, NICs) 11c, 12c, 13c and 14c, respectively. The nodes 11, 12, 13 and 14 are connected via a communication relay apparatus R11 in a manner communicatable with each other, and form a network. (i) The “multi-destination delivery method reliable for (relatively) short data” in the above-mentioned method (2) is, for example, realized using the above-mentioned “barrier synchronization” or “reduction to all nodes”. A circuit that realizes the “barrier synchronization” or “reduction to all nodes” is provided, for example, in the communication relay apparatus R11, or in a dedicated reduction apparatus (not depicted). When carrying out collective communication such as “gather” or “scatter”, the nodes 11, 12, 13 and 14 may use the reliable multi-destination delivery (“multi-destination delivery method reliable for (relatively) short data”) in the above-mentioned method (2) or the reliable multi-destination delivery (“reliable multi-destination delivery”) in the above-mentioned method (3) as a method of transmitting information that indicates the location of the communication buffer for storing communication data (transmission data). As a method of effectively realizing the reliable multi-destination delivery in the method (2), “barrier synchronization” or “reduction to all nodes” may be used. This point will be described later using FIGS. 9A through 13B or FIGS. 17 through 19.

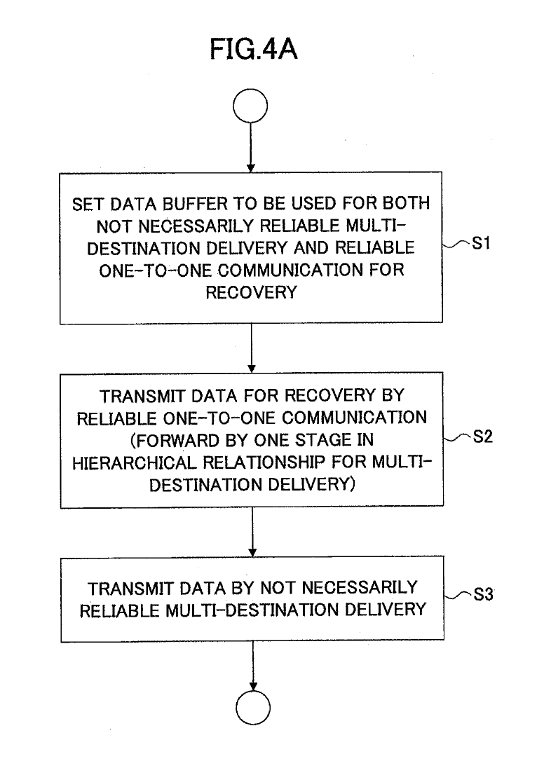

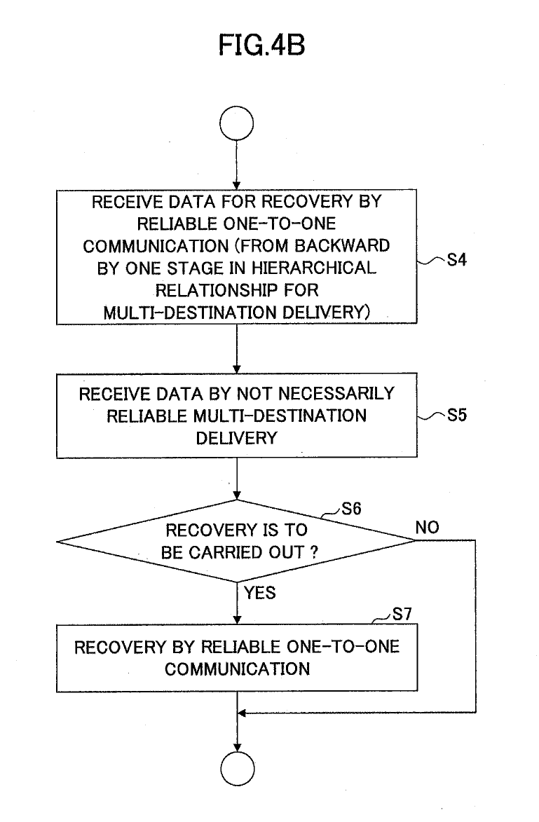

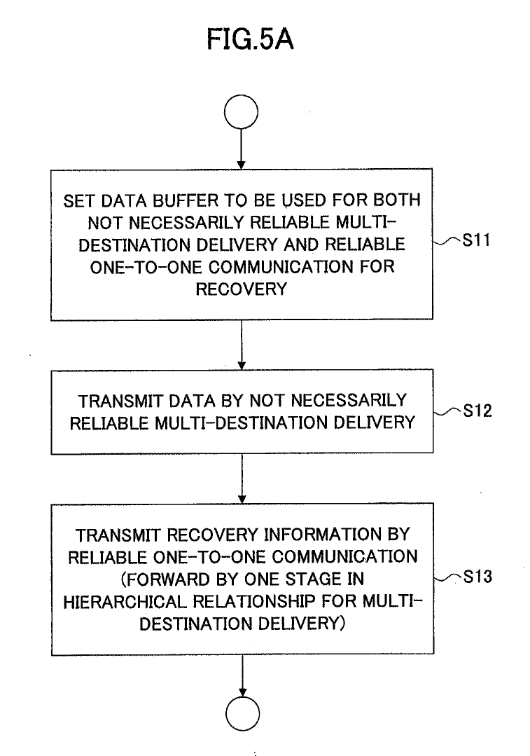

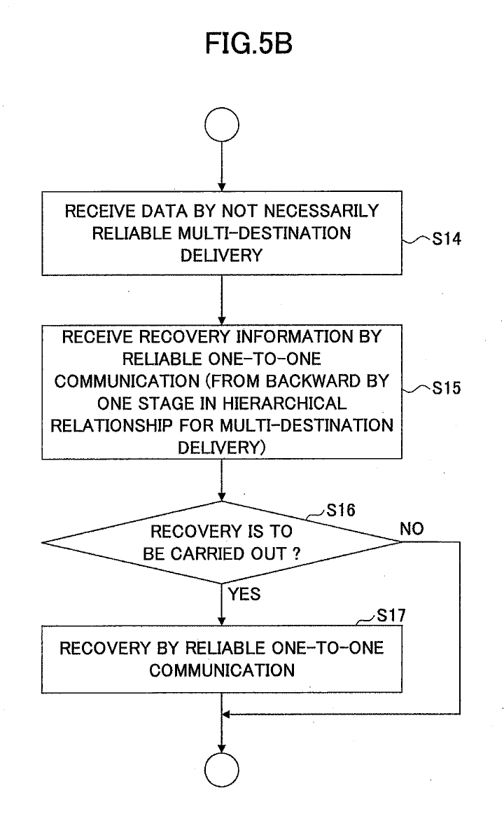

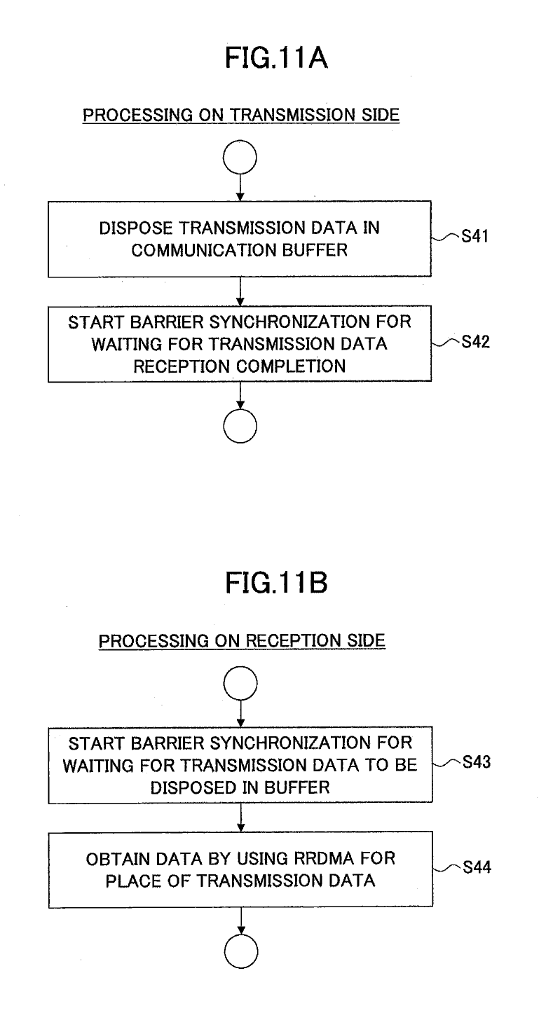

As (ii) the “buffer that exits in a communication device and operable by software of a node that carries out parallel computing” in the above-mentioned method (2), a communication device or a node N11 may be provided. This buffer may be used as a “data buffer” in step S1 of FIG. 4A or step S11 of FIG. 5A (to be described later) and a “buffer” in step S31 of FIG. 9A (to be described later), for example. Further, this buffer may be used as a “communication buffer” in step S41 of FIG. 11A (to be described later) or a “communication buffer” in step S101 of FIG. 15 (to be described later), for example.

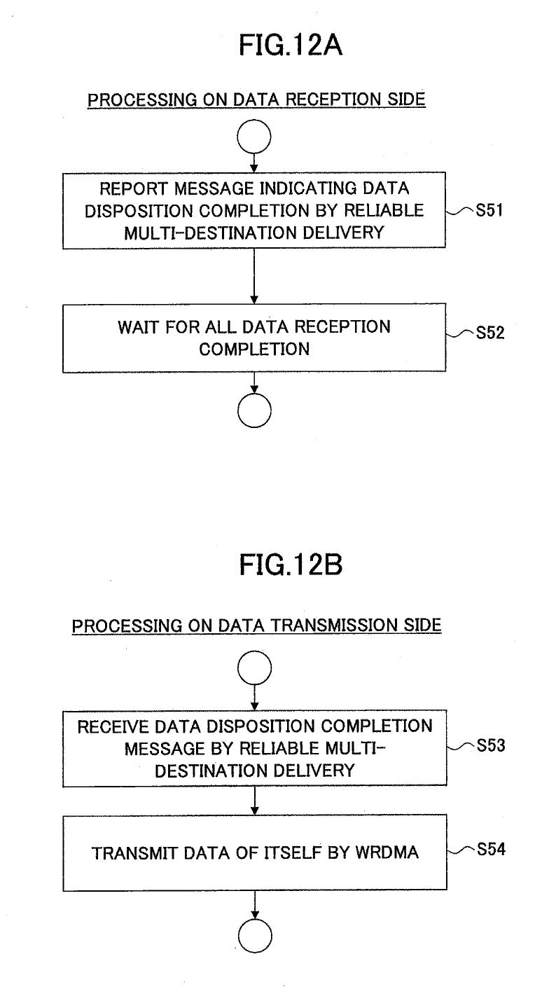

As (iii) the “mechanism for waiting for the plurality of items of data in parallel in a communication device” in the above-mentioned method (2), the following configuration may be considered, for example. That is, this mechanism (C11 in FIG. 2) may be a configuration to “wait for reception completion” in step S33 of FIG. 9A (to be described later), a configuration for “waiting for transmission data reception completion” in step S42 of FIG. 11A (to be described later), a configuration to “wait for all data reception completion” in step S52 of FIG. 12A (to be described later) or the like. As these configurations, those that carry out the barrier synchronization may be considered.

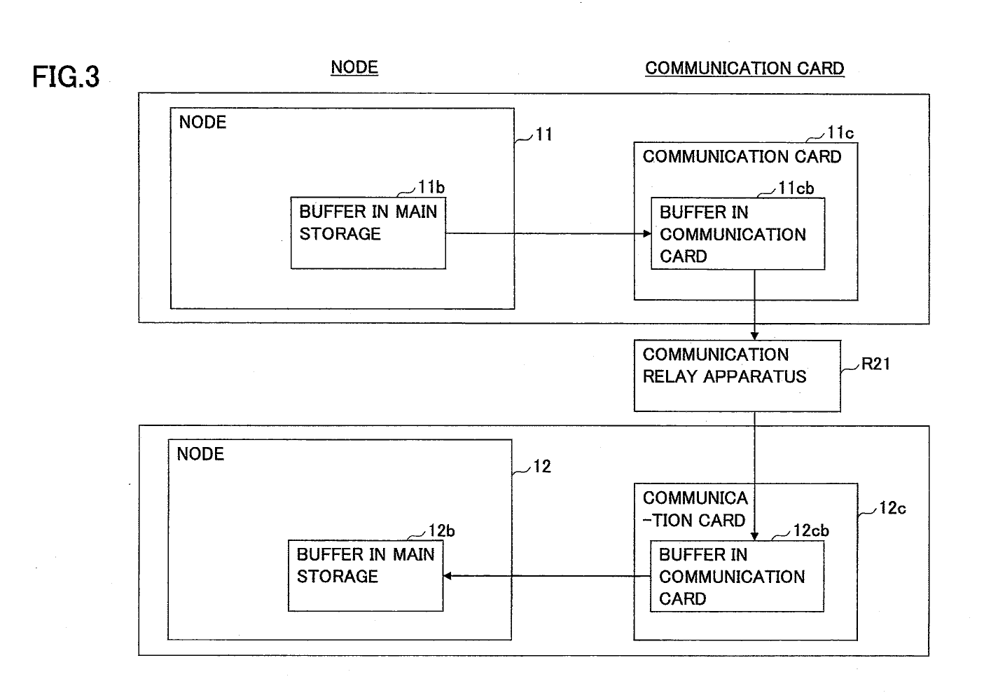

FIG. 3 is a block diagram illustrating a buffer in a communication card or a buffer that works with a communication relay apparatus, available as (ii) the “buffer that exists in a communication device and operable by software of a node that carries out parallel computing” in the above-mentioned method (2). The “buffer that works with a communication relay apparatus” refers to a buffer acting as a recording destination for automatically recording data as a function of a communication relay apparatus when it relays the data. The “buffer acting as a recording destination” corresponds to a buffer 12cb of a communication card 12c to which a communication relay apparatus R21 records data in the example of FIG. 3. It is also possible to provide separately a “dedicated node that holds a buffer” (not depicted), and in this case, the dedicated node that holds the buffer may be used as a result of being allocated in a communication procedure by software. That is, the software that provides the communication procedure may include a procedure of using the node that holds the buffer.

In FIG. 3, nodes 11 and 12 carry out parallel computing, and have communication cards (NICs or the like) 11c and 12c. The nodes 11 and 12 are connected via the communication relay apparatus R21 in a manner communicatable with each other, and form a network. The nodes 11 and 12 have buffers 11b and 12b, respectively, in their main storages. Further, the communication cards 11c and 12c have buffers 11cb and 12cb. Each of these buffers 11b, 12b, 11cb and 12cb is available as the above-mentioned “buffer that exists in a communication device and operable by software of a node that carries out parallel computing”. Further, in a large-scale network, a hierarchical relay process including several stages may be carried out. However, hereinafter, for the sake of convenience of explanation, only “one stage of relay process” is described in a case where the relay process is carried out.

In FIG. 3, in a case where the collective communication is carried out between the nodes including the nodes 11 and 12, for example, the data is transferred from the node 11 to the node 12. In this state, the data is transferred from the buffer 11b of the node 11 to the buffer 11cb of the communication card 11c, the data is further transferred from the buffer 11cb of the communication card 11c to the buffer 12cb of the communication card 12c via the communication relay apparatus R21, and the data is further transferred from the buffer 12cb of the communication card 12c to the buffer 12b of the node 12. The data transfer between the respective buffers may be carried out using the TCP/IP, or further using the RDMA function. Details of data transfer between the respective nodes will be described later using FIGS. 9A through 13B.

As (iii) the “mechanism for waiting for the plurality of items of data in parallel in a communication device” in the above-mentioned method (2), the above-mentioned “barrier synchronization” may be used, for example. As mentioned above, the barrier synchronization is a synchronization method in which the synchronization is completed when all nodes that participate in the synchronization call the function provided for the synchronization. Large-scale parallel computing systems frequently use networks having a high-speed barrier synchronization mechanism. A communication method for parallel computing according to an embodiment of the present invention may be applied to these parallel computing systems.

Next, a realization example of the above-mentioned method (3) will be described. According to the method (3), in a case where communication devices attached to respective nodes have “not necessarily reliable multi-destination delivery” functions, and also, “reliable one-to-one communication” functions, respectively, these functions may be combined and “reliable multi-destination delivery” functions may be realized. Specifically, by carrying out a recovery of communication data (transmission data) using the one-to-one communication, the reliability may be achieved. As a specific method of the recovery, (a) a method by retransmission (to be described later) and (b) a method of giving redundancy to transmission data (communication data) exist, for example.

As a result, it is possible to realize “reliable multi-destination delivery” using “not necessarily reliable multi-destination delivery”. For example, data to be used for a recovery of transmission data (hereinafter, simply referred to as “recovery information”) is transmitted by repetition of “one-to-one communication” operations. The transmission of recovery information may be carried out before or after transfer of the transmission data (communication data) using “not necessarily reliable multi-destination delivery”. The recovery information includes information to be used for a completeness check of transmission data and a recovery of transmission data, and for example, may include information related to a size of transmission data, an error detection code, and, if necessary, a timeout period and other information. The “reliable multi-destination delivery” realized by the above-mentioned method (3) may be used in the collective communication according to a communication method for parallel computing in an embodiment of the present invention, as “reliable multi-destination delivery” in step S32 of FIG. 9A and step S34 of FIG. 9B, for example. Similarly, the “reliable multi-destination delivery” realized by the method (3) may be used in the collective communication according to a communication method for parallel computing according to an embodiment of the present invention, as “reliable multi-destination delivery” in step S51 of FIG. 12A and step S53 of FIG. 12B, for example.

In a case where the transmission of recovery information is carried out before the transfer of transmission data (using “not necessarily reliable multi-destination delivery”), a reception-side node may determine correctness of the transmission data immediately after receiving the transmission data. Therefore, it is possible to shorten a time to allocate the communication buffer for each set of transmission data.

In a case where the transmission of recovery information is carried out after the transfer of transmission data (using “not necessarily reliable multi-destination delivery”), an error correction code may be embedded in advance in the transmission data. As a result, a recovery of the transmission data may be made without transferring the transmission data again unless the entire packet of the transmission data is lost.

As a specific method of the recovery of the transmission data (communication data), the following two methods (a) and (b) may be considered.

(a) Method by Retransmission:

(1) A reception-side node detects a packet abnormality in received data, and requests retransmission of the transmission data from a transmission-side node.

(2) In a case where a transmission-side node has detected a timeout for a reception confirmation response from a reception-side node, the transmission-side node retransmits the transmission data.

(b) Method of Giving Redundancy to Transmission Data:

It is possible to use Forward Error Correction (FEC) or the like. That is, in a case where the transmission data is transmitted by being divided (or segmented) into a plurality of packets, N+1 packets, for example, the packets are transmitted according to an error correction coding process. In this case, the transmission data is transmitted after being converted in such a manner that the original data may be restored when N packets of the N+1 packets are properly received.

Below, using FIGS. 4A through 7C, a realization example of the above-mentioned method (3) will be described.

First, using FIGS. 4A and 4B, a flow of operations in a case where the recovery information is transmitted before the transfer of transmission data will be described.

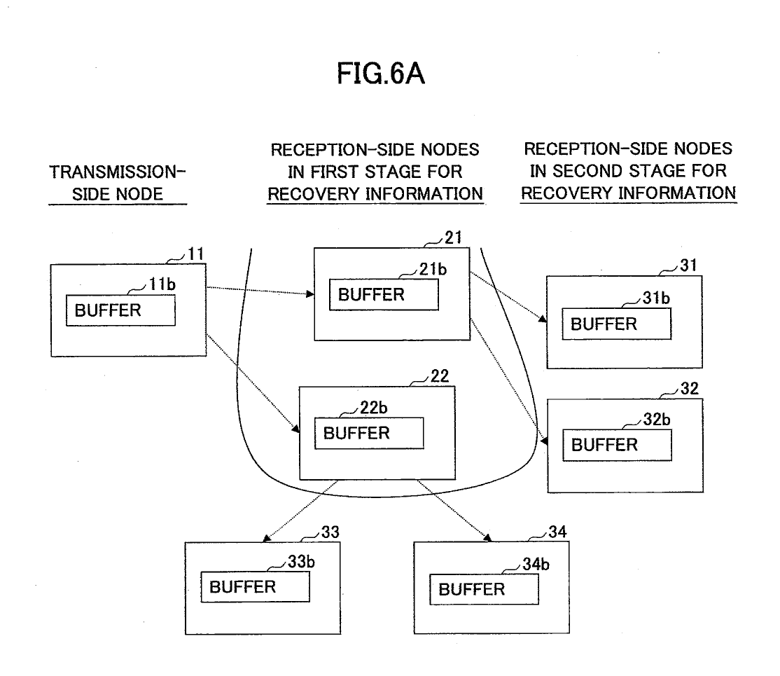

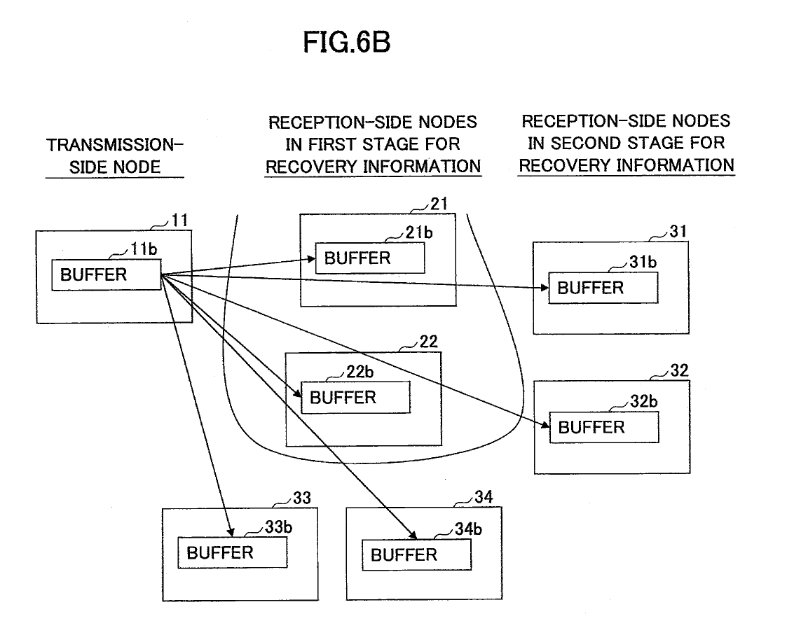

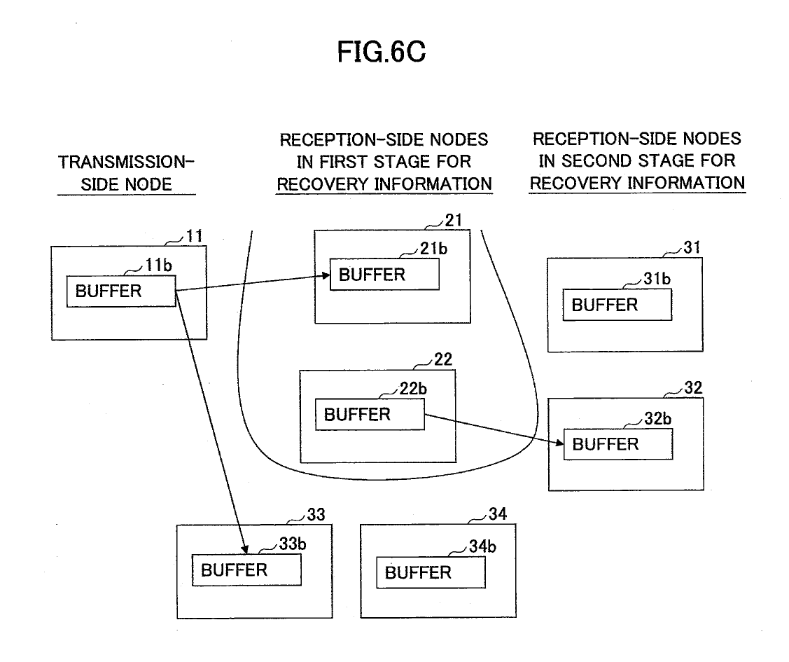

In step S1 of FIG. 4A, a transmission-side node sets a data buffer (communication buffer) to be used for both “not necessarily reliable multi-destination delivery” (in step S3, described later) and “one-to-one communication at a time of recovery” (in step S7, described later). Next, the transmission-side node transmits the recovery information by “reliable one-to-one communication” (in step S2). In this case, as will be described later using FIG. 6A, the recovery information is transferred between the nodes in sequence in respective stages (respective levels of hierarchy) of the multi-destination delivery. The respective stages (respective levels of hierarchy) of multi-destination delivery refer to the number of multi-destination delivery operations (or communication) when the multi-destination delivery operation is repeated to transfer the data in sequence. Further, in a case where the number of transmission destinations is two or more in each of the respective stages (levels of hierarchy) of multi-destination delivery as depicted in FIG. 6A, a “reliable one-to-one communication” operation is repeated a number of times corresponding to the number of transmission destinations, and thus, the multi-destination delivery for the plurality of transmission destinations may be achieved. The “reliable one-to-one communication” may be realized by, for example, using the RDMA function.

Next, the transmission-side node transmits transmission data by “not necessarily reliable multi-destination delivery” (in step S3).

In FIG. 4B, a reception-side node receives the recovery information that has been transmitted by the transmission-side node in step S2, by the above-mentioned “reliable one-to-one communication” (in step S4). Also in this case, the recovery information is transferred between the nodes in sequence in the respective stages (respective levels of hierarchy) of the multi-destination delivery. Next, the reception-side node receives the transmission data transmitted by the transmission-side node (using the “not necessarily reliable multi-destination delivery”) in step S3, by this “not necessarily reliable multi-destination delivery” (in step S5). Next, the reception-side node carries out a check for completeness (or completeness check) of the received transmission data (according to processing for error detection and correction, retransmission, or the like) based on the received recovery information, and determines whether a recovery of the transmission data is to be carried out (in step S6). In a case where the recovery of the transmission data is to be carried out (the received transmission data is incomplete) (step S6 YES), the reception-side node carries out the recovery of the received transmission data by retransmission using “reliable one-to-one communication” (in step S7), for example, and finishes the operation. As the “reliable one-to-one communication”, the communication using the RDMA function may be used. In a case where the recovery of the transmission data (according to the processing for error detection and correction, retransmission, or the like) is not to be carried out (the received transmission data is complete) (step S6 NO), the reception-side node finishes the operation.

Next, using FIGS. 5A and 5B, a flow of operations in a case where the recovery information is transmitted after the transfer of transmission data will be described.

In step S11 of FIG. 5A, a transmission-side node sets a data buffer (communication buffer) to be used for both “not necessarily reliable multi-destination delivery” (in step S12, described later) and “one-to-one communication at a time of a recovery” (in step S17, described later). Next, the transmission-side node transmits transmission data by “not necessarily reliable multi-destination delivery” (in step S12). As the “not necessarily reliable multi-destination delivery”, “multicast” may be used, for example, as mentioned above. Next, the transmission-side node transmits the recovery information by “reliable one-to-one communication” (in step S13). In this case, as will be described later using FIG. 6A, the recovery information is transferred between the nodes in sequence in respective stages (respective levels of hierarchy) of the multi-destination delivery. The respective stages (respective levels of hierarchy) of multi-destination delivery refer to, as mentioned above, the number of times the multi-destination delivery operation is repeated to transfer the data in sequence. Further, in a case where the number of transmission destinations is two or more in each of the respective stages (levels of hierarchy) of the multi-destination delivery as depicted in FIG. 6A, a “reliable one-to-one communication” operation is repeated a number of times corresponding to the number of transmission destinations, and thus, the multi-destination delivery for the plurality of transmission destinations may be achieved. The “reliable one-to-one communication” may be realized by, for example, using the RDMA function.

In FIG. 5B, the reception-side node receives the transmission data transmitted by the transmission-side node (using the “not necessarily reliable multi-destination delivery”) in step S12, by this “not necessarily reliable multi-destination delivery” (in step S14). Next, the reception-side node receives the recovery information transmitted by the transmission-side node (using the “reliable one-to-one communication”) in step S13, by this “reliable one-to-one communication” (in step S15). Also in this case, the recovery information is transferred between the nodes in sequence in the respective stages (levels of hierarchy) of the multi-destination delivery. Next, the reception-side node carries out a completeness check of the received transmission data based on the received recovery information, and determines whether a recovery of the received transmission data is to be carried out (in step S16). In a case where the recovery of the received transmission data is to be carried out (the received transmission data is incomplete) (step S16 YES), the reception-side node carries out the recovery of the received transmission data by retransmission using “reliable one-to-one communication” (step S17), for example, and finishes the operations. As the reliable one-to-one communication, communication using a RDMA function may be used, for example. In a case where the recovery of the received transmission data is not to be carried out (the received transmission data is complete) (step S16 NO), the reception-side node finishes the operation.

Next, using FIGS. 6A, 6B and 6C, the case where the recovery information is transmitted before the transfer of transmission data described above using FIGS. 4A and 4B will be described using a specific example.

The specific example of FIGS. 6A, 6B and 6C is a case in which the reception-side node uses a Read Remote Direct Memory Access (RRDMA) function in a case where the reception-side node carries out a recovery of transmission data by retransmission. The RRDMA function refers to a type of the above-mentioned RDMA function that is a function of designating an address of a memory of another node and directly transferring data, and the RRDMA function is for a case where communication is initiated from the reception side. The RRDMA function may sometimes be called a “Get” function. In a case of the example of FIGS. 6A, 6B and 6C, the communication network for parallel computing has the RRDMA function, and the recovery of transmission data by retransmission is started by the reception-side node using the RRDMA function. For example, in step of FIG. 6C to be described later, the reception-side node again transfers (from another node) transmission data (once received in step of FIG. 6B) to the reception-side node itself using the RRDMA function. This specific example uses the RRDMA function (the type of the RDMA function, as mentioned above), and therefore, may be regarded to be a combination of the above-mentioned methods (3) and (4).

The RDMA function is an accessing function of directly writing a value in a memory of a remote host without using (that is, without intervention by) a central processing unit (CPU). By the RDMA function, it may be expected that the communication may be carried out with a very small delay while the load on the CPU may be very small. The RDMA function is defined as a standard function in communication standards such as InfiniBand, Virtual Interface Architecture (VIA), iWarp, and the like. The iWarp includes a function (RDMA over TCP/IP) of carrying out the RDMA function using a TCP/IP connection in Ethernet. Realization of the RDMA function in any one of the standards does not differ therebetween in terms of basic functions (although details of the implementations differ). “RDMA Protocol: Improvement in Network Performance” (URL:http://h50146.www5.hp.com/products/servers/proliant/whitepaper/wp049_{—}060331/pdfs/wp049_{—}060330.pdf (on May 14, 2009)) describes techniques of the above-mentioned RDMA over TCP/IP and RDMA over InfiniBand.

In the case of the example of FIGS. 6A, 6B and 6C, a transmission-side node 11 carries out the multi-destination delivery to reception-side nodes 21, 22, 31, 32, 33 and 34. As depicted in FIGS. 6A, 6B and 6C, the nodes 11, 21, 22, 31, 32, 33 and 34 set data buffers (communication buffers) 11b, 21b, 22b, 31b, 32b, 33b, 34b, respectively. In the first step, as depicted in FIG. 6A, the recovery information is transferred to the reception-side nodes 21 and 22 in a first stage of the multi-destination delivery for recovery information, from the transmission-side node 11, by the multi-destination delivery. Actually, as mentioned above, the reliable one-to-one communication is used, and the recovery information is transmitted to the reception-side nodes in sequence. As mentioned above, the recovery information includes the size of data, the error detection code, the timeout period, and the like, as information to be used for the transmission error detection and the recovery of the data to be transmitted (transmission data).

Next, the reception-side nodes 21 and 22 in the first stage of the multi-destination delivery for recovery information, which receive the recovery information, then transmit the recovery information by the multi-destination delivery to the reception-side nodes 31, 32, 33 and 34 in a second stage of the multi-destination delivery for recovery information, respectively. Also in this case, as mentioned above, the recovery information is transmitted in sequence using the reliable one-to-one communication from the nodes 21 and 22 to the nodes 31, 32, 33 and 34.

In the second step, as depicted in FIG. 6B, the transmission-side node 11 transmits the transmission data to all of the reception-side nodes 21, 22, 31, 32, 33 and 34 by “not necessarily reliable multi-destination delivery” (for example, “multicast”). As a result, from the buffer 11b of the transmission-side node 11, the transmission data is transferred to the buffers 21b, 22b, 31b, 32b, 33b and 34b of the reception-side nodes 21, 22, 31, 32, 33 and 34. The above-mentioned “not necessarily reliable multi-destination delivery” may be, for example, multi-destination delivery according to “multicast”, as mentioned above.

In the third step, as depicted in FIG. 6C, the reception-side nodes 21, 32 and 33, for example, for which a recovery of the received transmission data by retransmission is to be carried out (in FIG. 4B, step S6 YES), carry out recoveries of the received transmission data using the RRDMA function, respectively.

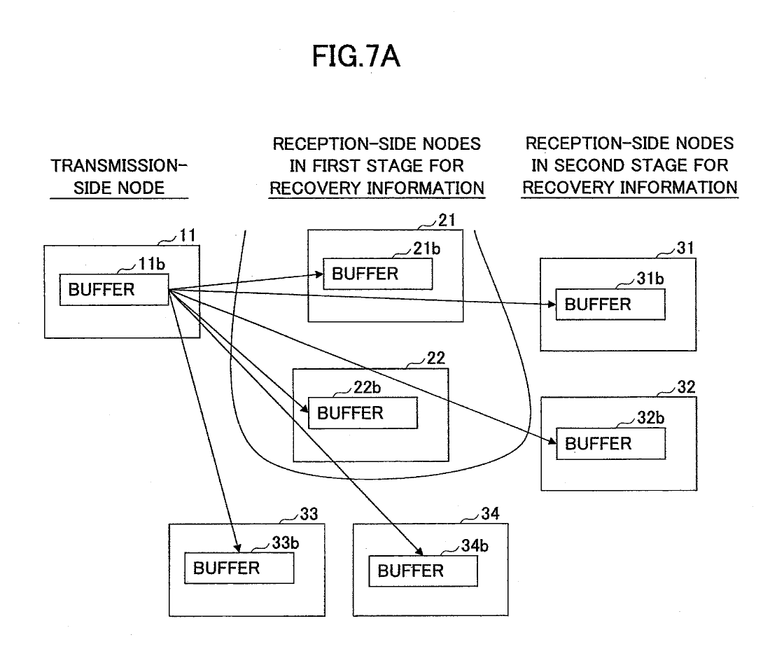

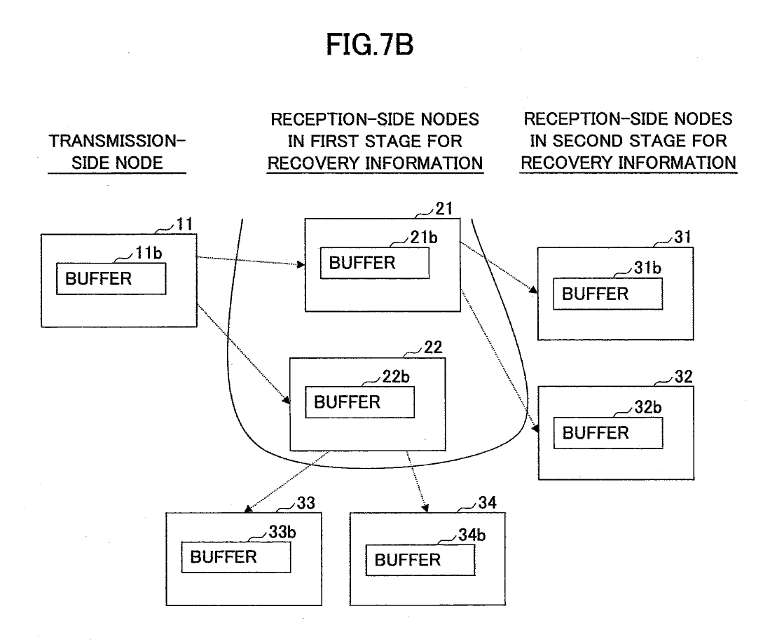

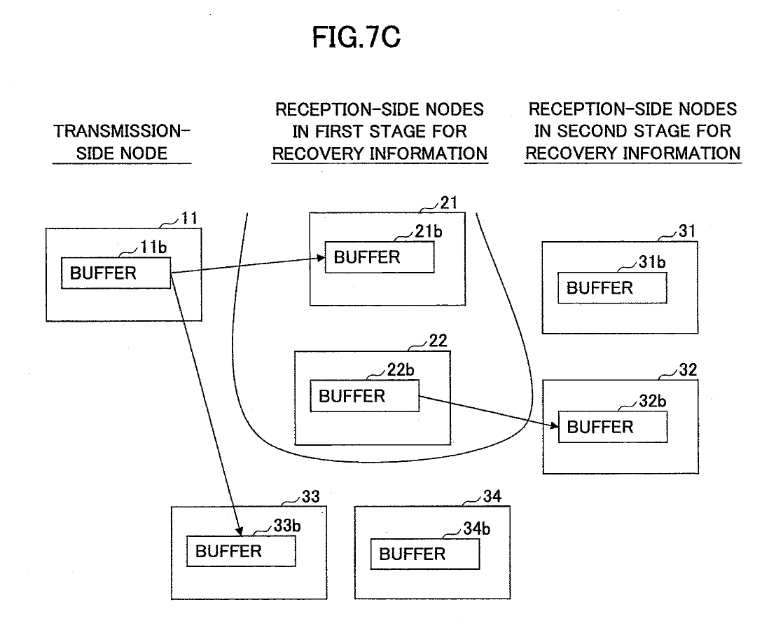

Next, using FIGS. 7A, 7B and 7C, the case where the recovery information is transmitted after the transfer of transmission data described above using FIGS. 5A and 5B will be described using a specific example.

The specific example of FIGS. 7A, 7B and 7C, which are the same as the specific example of FIGS. 6A, 6B and 6C described above, is a case in which the reception-side node uses the RRDMA function when the reception-side nodes carry out the recovery of the transmission data by retransmission. Also this specific example uses the RRDMA function, and therefore, may be regarded to be a combination of the above-mentioned methods (3) and (4).

Also in the specific example of FIGS. 7A, 7B and 7C, which is the same as the specific example of FIGS. 6A, 6B and 6C, the transmission-side node 11 carries out the multi-destination delivery to reception-side nodes 21, 22, 31, 32, 33 and 34. As depicted in FIGS. 7A, 7B and 7C, the nodes 11, 21, 22, 31, 32, 33 and 34 set data buffers (communication buffers) 11b, 21b, 22b, 31b, 32b, 33b, 34b, respectively. In the first step, as depicted in FIG. 7A, the transmission-side node 11 transmits the transmission data to all of the reception-side nodes 21, 22, 31, 32, 33 and 34 by “not necessarily reliable multi-destination delivery”. As a result, from the buffer 11b of the transmission-side node 11, the transmission data is transferred to the buffers 21b, 22b, 31b, 32b, 33b and 34b of the reception-side nodes 21, 22, 31, 32, 33 and 34. The above-mentioned “not necessarily reliable multi-destination delivery” may be, for example, the multi-destination delivery according to “multicast”.

In the second step, as depicted in FIG. 7B, the recovery information is transferred to the reception-side nodes 21 and 22 in a first stage of the multi-destination delivery for the recovery information, from the transmission-side node 11, by the multi-destination delivery. Actually, as mentioned above, “reliable one-to-one communication” is used, and the recovery information is transmitted to the reception-side nodes 21 and 22 in sequence. As mentioned above, the recovery information includes the size of data, the error detection code, the timeout period, and the like, as information to be used for the transmission error detection and the recovery of the data to be transmitted (transmission data). An example of a data format of the recovery information will be described later using FIG. 21.

Next, the reception-side nodes 21 and 22 in the first stage of the multi-destination delivery for recovery information, which receive the recovery information, then transmit the recovery information by the multi-destination delivery to the reception-side nodes 31, 32, 33 and 34 in a second stage of the multi-destination delivery for the recovery information, respectively. Also in this case, as mentioned above, the recovery information is transmitted in sequence by “reliable one-to-one communication” from the nodes 21 and 22 to the nodes 31, 32, 33 and 34.

In the third step, as depicted in FIG. 7C, the reception-side nodes 21, 32 and 33, for example, for which the recovery of the received transmission data by retransmission is to be carried out (in FIG. 5B, step S16 YES), carry out recoveries of the received transmission data using the RRDMA function, respectively.

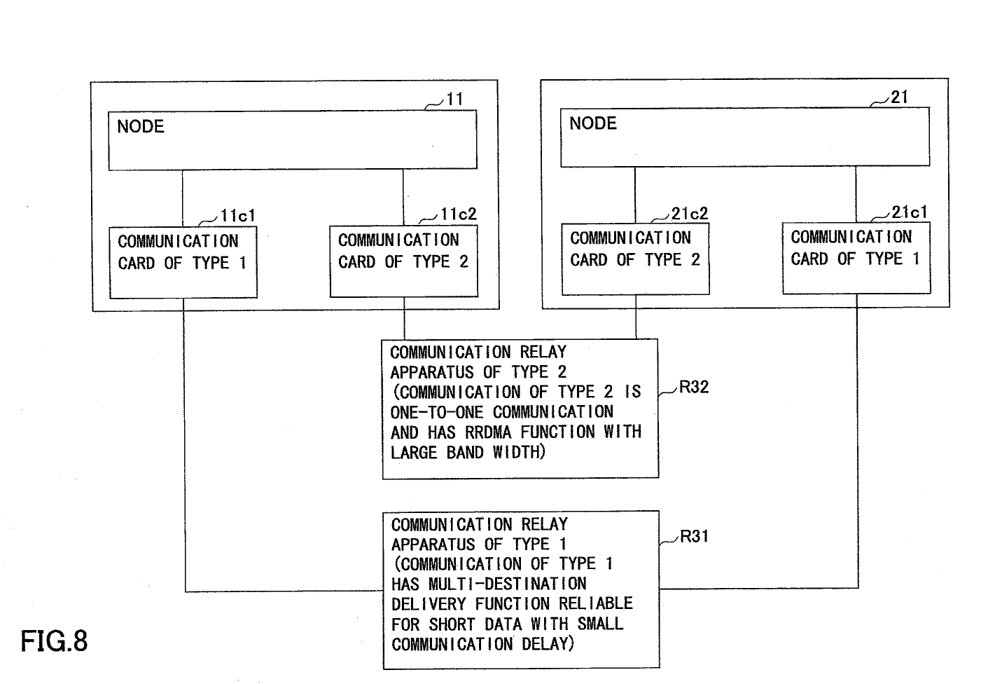

Next, using FIG. 8, the above-mentioned method (5) will be described. In an example of FIG. 8, a first (communication) network and a second (communication) network are used as the above-mentioned “plurality of networks” in the method (5).

In FIG. 8, the first network has a communication relay apparatus R31, and supports “multi-destination delivery reliable for short data” (corresponding to the above-mentioned “multi-destination delivery method reliable for (relatively) short data” also the same hereinafter). The “multi-destination delivery reliable for short data” may be used as “reliable multi-destination delivery” in step S32 of FIG. 9A and step S34 of FIG. 9B (to be described later), for example, in a communication method for parallel computing according to an embodiment of the present invention. Similarly, the “multi-destination delivery reliable for short data” may be used as “reliable multi-destination delivery” in step S51 of FIG. 12A and step S53 of FIG. 12B (to be described later), for example, in a communication method for parallel computing according to an embodiment of the present invention. That is, a transmission-side node 11 uses a communication card 11c1, and transmits “information that indicates disposition of communication data in a communication buffer” via the communication relay apparatus R31 of the first network. Each reception-side node 21 uses a communication card 21c1, and receives the “information that indicates disposition of communication data in a communication buffer” via the communication relay apparatus R31 of the first network.

On the other hand, the second network has a communication relay apparatus R32, and supports a “reliable one-to-one communication” method (i.e., a communication method using the RRDMA function, a Write Remote Direct Memory Access (WRDMA) function, or the like). The WRDMA function refers to another type of the RDMA function that is a function of designating an address of a memory of another node and directly transferring data, and the WRDMA function is a function for a case where the communication is initiated from the transmission side. The “reliable one-to-one communication” method may be used as a measure to transfer the data using the “RRDMA” function in step S35 of FIG. 9B, for example. Similarly, the “reliable one-to-one communication” method may be used as a measure to transfer the data using the “WRDMA” function in step S54 of FIG. 12B (according to an embodiment 2 of the present invention concerning “gather”, described later), for example. That is, each reception-side node 21 uses a communication card 21c2, and receives the communication data (transmission data) via the communication relay apparatus R32 of the second network from a communication card 11c2 of the transmission-side node 11 (step S35 of FIG. 9B). Alternatively, each “transmission-side” node 21 may use the communication card 21c2, and transmit the communication data (transmission data) to the reception-side node 11 via the communication relay apparatus R32, and further, via the communication card 11c2 (step S54 of FIG. 12B).

Thus, according to the method (5), for the respective “multi-destination delivery reliable for short data” and “reliable one-to-one communication” in the communication method according to an embodiment of the present invention, it is possible to use different networks, i.e., the first and second networks.

Below, communication methods for parallel computing according to embodiments of the present invention will be described using FIGS. 9A through 13B.

In the communication methods for parallel computing according to the embodiments of the present invention, the network part that has the dominant constraint from the view point of the amount of resources depending on the system configuration is shared by the one-to-one communication and the plurality of types of collective communication including “scatter” and “gather” among various types of node-to-node communication in parallel computing. That is, the network part that has the dominant constraint from the viewpoint of the amount of resources depending on the system configuration may be used at a time of the one-to-one communication among various types of node-to-node communication in parallel computing. Simultaneously, the network part may be used also at a time of the plurality of types of collective communication including “scatter” and “gather” among the various types of node-to-node communication in parallel computing. As a result, it is possible to reduce the costs for realizing the system and also maintain the performance of the entire system, in comparison to a case where the network to be used at the time of the one-to-one communication and the network to be used at the time of the plurality of types of collective communication including “scatter” and “gather” are provided separately.

First, using FIGS. 9A through 11B, a communication method for parallel computing according to an embodiment 1 of the present invention will be described.

According to the embodiment 1, the multi-destination delivery reliable for short data and the RRDMA function as the one-to-one communication are used, and the speed of “scatter” is increased. As mentioned above, according to the RDMA function, the communication may be carried out with a very small delay. As mentioned above, the RRDMA function is the type of the RDMA function for the case where communication is initiated from the reception side, and therefore, it is possible to increase the speed of “scatter” by carrying out the data transfer in “scatter” using the RRDMA.

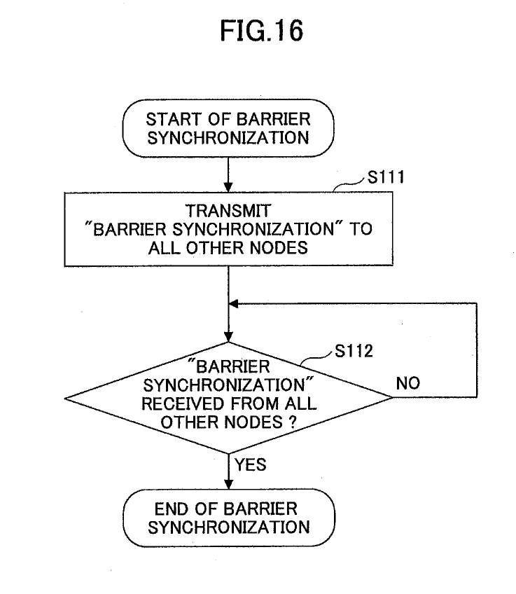

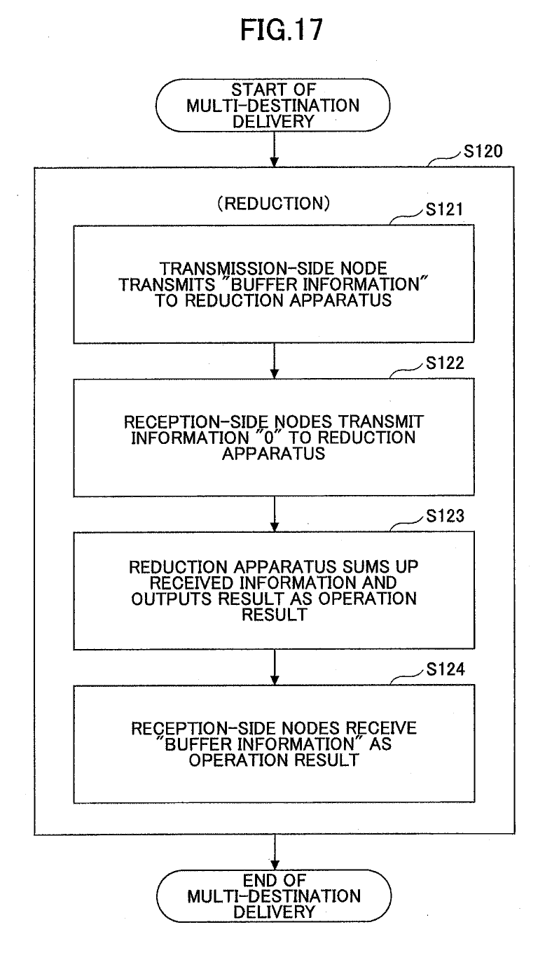

In FIG. 9A, a transmission-side node stores a plurality of sets of communication data to be transmitted to a plurality of reception-side nodes in a disposition within communication buffers (in step S31). As the communication buffers, for example, a buffer that a communication device or the node N11 depicted in FIG. 2 has, each buffer 11b, 11cb, 12b or 12cb depicted in FIG. 3, or the like, may be used. Next, the transmission-side node reports messages indicating the completion of the disposition of the communication data in the communication buffers (simply referred to as a “disposition completion message”, hereinafter) using “multi-destination delivery reliable for short data” (in step S32). The “disposition completion message” corresponds to “information that indicates disposition of communication data in communication buffers”. The disposition completion message (information that indicates the disposition of communication data in communication buffers) includes “messages indicating that the communication data is stored in a disposition within the communication buffers” and “information indicating the disposition state of the communication data in the communication buffers”. The information indicating the disposition state of the communication data in the communication buffers indicates which parts (buffers) of the communication buffers in which the sets of communication data provided for the reception-side nodes are stored. This point will be described later using FIG. 20. The above-mentioned “multi-destination delivery reliable for short data” in step S32 may be realized by combining the “not necessarily reliable multi-destination delivery” and “reliable one-to-one communication” described above using FIGS. 4A through 7C. This point will be described later using FIG. 9C. Alternatively, the above-mentioned “multi-destination delivery reliable for short data” in step S32 may be realized by the multi-destination delivery using “barrier synchronization” described later using FIGS. 15 and 16. Further, as another alternative, the above-mentioned “multi-destination delivery reliable for short data” in step S32 may be realized by the multi-destination delivery using “reduction to all nodes” realized by “a reduction apparatus” described later using FIGS. 17 through 19.

Next, the transmission-side node waits for reception completion notifications that indicate that the reception-side nodes received the communication data (step S33). When the reception completion notifications from the reception-side nodes arrive, the transmission-side node finishes the “scatter” operation.

In FIG. 9B, the reception-side nodes receive the above-mentioned disposition completion message, transmitted by the “multi-destination delivery reliable for short data” in step S32, by the same “multi-destination delivery reliable for short data” (in step S34). Next, the reception-side nodes receive the communication data provided for themselves from the communication buffers by the RRDMA function (in step S35). More specifically, the reception-side nodes obtain the corresponding addresses of the communication buffers based on the above-mentioned information indicating which parts (buffers) of the communication buffers in which the sets of communication data provided for the reception-side nodes are stored, included in the received disposition completion messages. The reception-side nodes may read and obtain the respective sets of the communication data provided for themselves by designating the thus obtained corresponding addresses of the communication buffers and carrying out RRDMA. When thus having received the respective sets of communication data provided for themselves by the RRDMA function, the reception-side nodes transmit reception completion notifications to the transmission-side node (step S36) and finishes the “scatter” operations.

FIG. 9C depicts the above-mentioned example in which the above-mentioned “multi-destination delivery reliable for short data” in step S32 is realized by combining the “not-necessarily reliable multi-destination delivery” and “reliable one-to-one communication” described above using FIGS. 4A through 7C.

In step S32-1 of FIG. 9C, the disposition completion messages are transmitted by the transmission-side to the reception-side nodes by “not necessarily reliable multi-destination delivery” (corresponding to steps S3 and S5 in FIGS. 4A and 4B, for example). In step S32-2, each reception-side node carries out a check for completeness of the received disposition completion message and determines whether a recovery of the disposition completion message is to be carried out (corresponding to step S6 in FIG. 4B, for example). In a case where the recovery of the disposition completion message is to be carried out (the received disposition completion message is incomplete) (step S32-2 YES), the reception-side node carries out the recovery of the disposition completion message by retransmission using the reliable one-to-one communication (step S32-3) (corresponding to step S7 in FIG. 4B, for example), for example, and finishes the operation. In a case where a recovery of the disposition completion message is not to be carried out (the received disposition completion message is complete) (step S32-2 NO), the reception-side node finishes the operation.

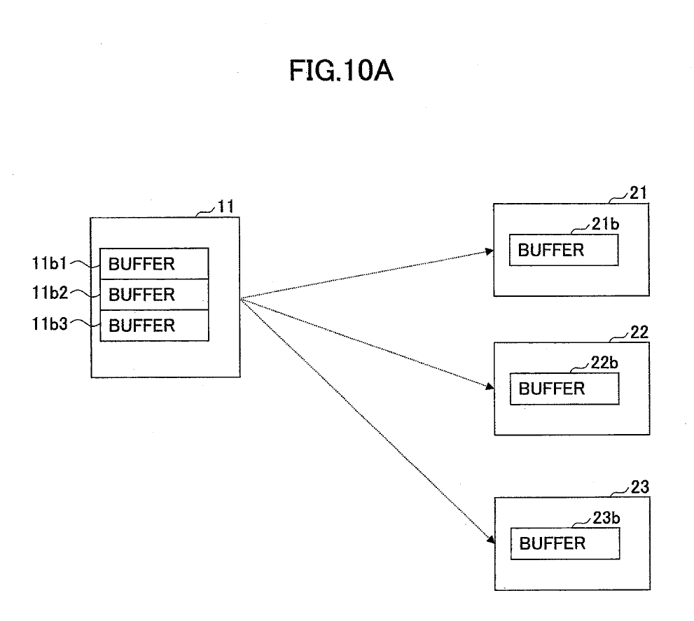

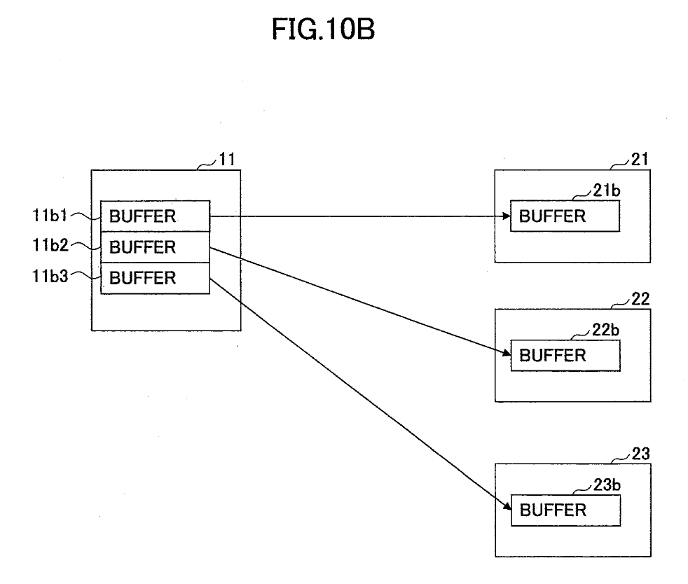

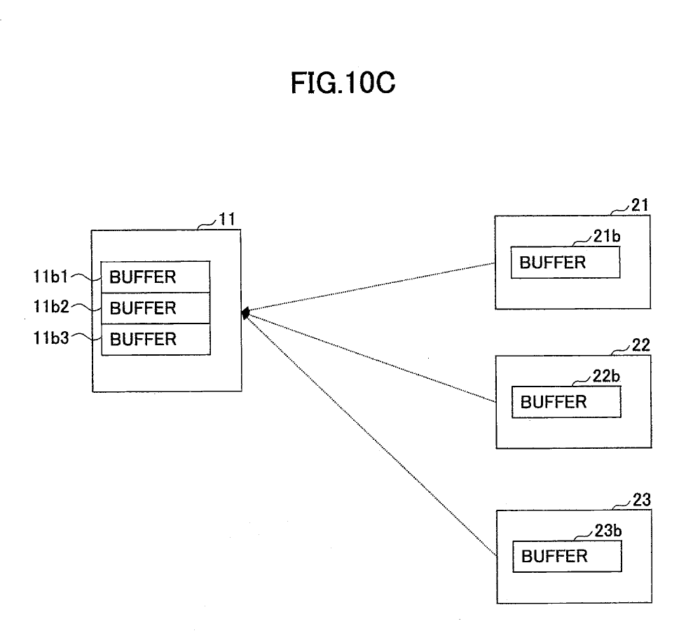

FIGS. 10A, 10B and 10C depict a specific example of the embodiment 1 described above using FIGS. 9A and 9B. In the first step depicted in FIG. 10A, the transmission-side node 11 stores a sequence (a plurality of sets) of communication data in a disposition within buffers 11b1, 11b2 and 11b3, and notifies of the above-mentioned disposition completion messages to all of the other nodes (reception-side nodes) 21, 22 and 23, by the “multi-destination delivery reliable for short data”. Since the notification is thus transmitted by the multi-destination delivery, the common disposition completion messages are notified to the nodes 21, 22 and 23. The reception-side nodes 21, 22 and 23 receive the common disposition completion messages, and may recognize the respective parts (buffers) of the communication buffers in which the sets of the communication provided for themselves are stored, according to a predetermined rule, for example.

In the second step depicted in FIG. 10B, the nodes other than the transmission-side node 11 (reception-side nodes) 21, 22 and 23 read and obtain the respective sets of communication data provided for themselves from the communication buffers by the RRDMA function. The nodes (reception-side nodes) 21, 22 and 23 that receive the sets of communication data store the sets of communication data in their buffers 21b, 22b and 23b, respectively. Since this specific example is the example of “scatter”, the respective sets of communication data stored in a disposition within the buffers 11b1, 11b2 and 11b3 of the transmission-side node 11 may be different from each other. The reception-side nodes 21, 22 and 23 may recognize that the sets of communication data provided for themselves are stored in a disposition within the buffers 11b1, 11b2 and 11b3, respectively, as follows. That is, the reception-side nodes 21, 22 and 23 may recognize the buffers 11b1, 11b2 and 11b3 in which the sets of communication data provided for themselves are stored, based on the above-mentioned “information indicating which parts (buffers) of the communication buffers the sets of communication data provided for the reception-side nodes are stored in the disposition included in the above-mentioned disposition completion messages. Then, the reception-side nodes 21, 22 and 23 designate the corresponding buffers 11b1, 11b2 and 11b3, respectively, and carry out the RRDMA. As a result, the reception-side nodes 21, 22 and 23 read and receive the sets of communication data from the corresponding buffers 11b1, 11b2 and 11b3, respectively. Therefore, as mentioned above, in the case where the sets of communication data stored in the disposition within the buffers 11b1, 11b2 and 11b3 are different from each other, the reception-side nodes 21, 22 and 23 may receive the sets of communication data different from each other. Thus, the “scatter” may be realized.

In the third step depicted in FIG. 10C, the reception-side nodes 21, 22 and 23 that have received the sets of communication data provided for themselves in the second step transmit the reception completion notifications to the transmission-side node 11. The transmission-side node 11 receives the reception completion notifications. As a result, the “scatter” operation is finished.

As to the “multi-destination delivery reliable for short data” used in the above-mentioned embodiment 1 (“reliable multi-destination delivery” in step S32 of FIG. 9A) and to “wait for the reception completion” (step S33) will be further described.

In a communication method for parallel computing according to an embodiment of the present invention, “all of transmission-side node(s) and reception-side node(s) being synchronized together at specific positions of respective programs” is a precondition for the multi-destination delivery as node-to-node communication. In this case, information related to the addresses of communication buffers with which specific multi-destination deliveries will be carried out are exchanged in advance between the transmission-side node(s) and reception side-node(s). As a result, it is possible to realize a function of the multi-destination delivery by combining the “function of barrier synchronization” and the “RRDMA function as reliable one-to-one communication” (for example, steps S102 and S103 in FIG. 15, to be described later).

For example, as (an interface provision of) a standard communication library for parallel computing, Message Passing Interface (MPI) (for example, see “MPI: A Message-Passing Interface Standard”, Message Passing Interface Forum, Jun. 23, 2008 (URL: http://www.mpi-forum.org/docs/mpi21-report.pdf (on Jul. 29, 2009)), “MPI Reference, 3 Collective Communication”, Tokyo Institute of Technology, Hirose Laboratory (URL:http://www.cv.titech.ac.jp/˜hiro-lab/study/mpi_reference/chapter3.html (on Jul. 29, 2009)), and An Online Publishing Project of Addison-Wesley Inc., Argonne National Laboratory, and the NSF Center for Research on Parallel computing. “Designing and Building Parallel Programs v1.3”/dbpp@mcs.anl.gov, “Part II: Tools, 8 Message Passing Interface, 8.3 Global Operations” (URL: http://www.it.uom.gr/teaching/dbpp/text/node97.html (on Jul. 29, 2009))) exists. According to multi-destination delivery in the MPI, a reception side(s) and a transmission side(s) together designate arguments indicating “transmission side” and “reception side” and call the same function “MPI_Bcast( ). Therefore, in this case, the above-mentioned precondition that “all of transmission-side node(s) and reception-side node(s) being synchronized together at specific positions of respective programs” is satisfied.

Further, the above-mentioned information related to the addresses of the communication buffers to be exchanged in advance may be made to be different for the reception-side nodes. Then, the reception-side nodes may designate different addresses of the communication buffers of the transmission-side node, and receive the sets of communication data. Thus, it is consequently possible to realize the “function of “scatter” in which a single transmission-side node transmits a sequence of data simultaneously, and the reception-side nodes receive different parts of the sequence of data, respectively”. An embodiment of the present invention in this case will be described using FIGS. 11A and 11B as a variant embodiment of the above-mentioned embodiment 1.

According to the variant embodiment of the embodiment 1, as mentioned above, the addresses of communication buffers to be exchanged in advance are made to be different for the reception-side nodes. That is, the information related to the addresses of the communication buffers is exchanged in advance between the transmission-side node and the reception-side nodes such that the reception-side nodes will have the following information. That is, as a result of the exchange of information, among the buffers 11b1, 11b2 and 11b3 of the transmission-side node 11 as depicted in FIGS. 10A, 10B and 10C, the reception-side node 21 has the information concerning the buffer 11b1, the reception-side node 22 has the information concerning the buffer 11b2, and the reception-side node 23 has the information concerning the buffer 11b3, for example. In this state, the transmission-side node 11 stores the sets of communication data in a disposition within the communication buffers 11b1, 11b2 and 11b3, respectively, in step S41 of FIG. 11A. After finishing the disposition, the transmission-side node 11 transmits a synchronization signal for the “barrier synchronization for waiting for communication data disposition completion”.

Then, in step S42, the transmission-side node transmits a synchronization signal for the “barrier synchronization for waiting for reception completion” for the communication data by the reception-side nodes 21, 22 and 23. The “barrier synchronization for waiting for reception completion” is finished in the transition-side node at a time when the transmission-side node 11 receives the synchronization signals for the “barrier synchronization for waiting for reception completion” from the reception-side nodes 21, 22 and 23. Thus, at a time when all the nodes including the transmission-side node 11 and the reception-side nodes 21, 22 and 23 received the synchronization signals for the “barrier synchronization for waiting for reception completion”, the “barrier synchronization for waiting for reception completion” is finished. When the “barrier synchronization for waiting for reception completion” is thus finished, the “scatter” operation is finished.

On the other hand, in step S43 of FIG. 11B, the reception-side nodes 21, 22 and 23 transmit the synchronization signals for the “barrier synchronization for waiting for communication data disposition completion”. The “barrier synchronization for waiting for communication data disposition completion” is finished at a time when all the nodes including the transmission-side node 11 and the reception-side nodes receive the above-mentioned synchronization signals of the “barrier synchronization for waiting for communication data disposition completion”. Therefore, in order for the “barrier synchronization for waiting for communication data disposition completion” to finish, the transmission-side node 11 may transmit the synchronization signal for the “barrier synchronization for waiting for communication data disposition completion”. In this regard, as mentioned above, the transmission-side node 11 transmits the synchronization signal for the “barrier synchronization for waiting for communication data disposition completion” after completing disposition of the sets of communication data in the communication buffers 11b1, 11b2 and 11b3 (step S41 of FIG. 11A). Therefore, when the “barrier synchronization for waiting for communication data disposition completion” is finished, it means that the disposition of the sets of communication data in the communication buffers 11b1, 11b2 and 11b3 by the transmission-side node is completed. Therefore, at a time when the “barrier synchronization for waiting for communication data disposition completion” finishes, the reception-side nodes 21, 22 and 23 carry out the RRDMA based on the information related to the addresses (exchanged in advance) of the communication buffers 11b1, 11b2 and 11b3, respectively.

As mentioned above, as a result of the exchange of the information related to the addresses of the communication buffers 11b1, 11b2 and 11b3 of the transmission-side node 11 as depicted in FIGS. 10A, 10B and 10C, the reception-side node 21 has the information concerning the buffer 11b1, the reception-side node 22 has the information concerning the buffer 11b2, and the reception-side node 23 has the information concerning the buffer 11b3, for example. Therefore, the reception-side nodes 21, 22 and 23 may designate the communication buffers 11b1, 11b2 and 11b3 in which the sets of communication data provided for themselves, respectively, and carry out the RRDMA. After obtaining the sets of communication data provided for themselves, respectively, as a result of the RRDMA, the reception-side nodes transmit the synchronization signal for the “barrier synchronization for waiting for reception completion” as mentioned above. As a result, as mentioned above, the “scatter” operation is finished.

Next, a communication method for parallel computing according to the embodiment 2 of the present invention will be described.

According to the embodiment 2, the above-mentioned WRDMA function as the node-to-node communication is used, and the speed of the “gather” is increased.

In FIG. 12A, a reception-side node reports “information that indicates disposition of sets of communication data to receive from the transmission-side nodes in communication buffers” to the transmission-side nodes by the “multi-destination delivery reliable for short data” (step S51). The above-mentioned “information that indicates disposition of sets of communication data (to receive from the transmission-side nodes) in communication buffers” in the case of the embodiment 2 concerning the “gather” includes “information that indicates in which parts (buffers) of the communication buffers the transmission-side nodes will store (write) the sets of communication data”. A specific example of the “information that indicates in which parts (buffers) of the communication buffers the transmission-side nodes will store (write) the sets of communication data” will be described later using FIG. 20. As the communication buffers, for example, a buffer of a communication device or the node N11 depicted in FIG. 2, such as each of the buffers 11b, 11cb, 12b or 12cb depicted in FIG. 3, or the like, may be used.

Next, the “multi-destination delivery reliable for short data” in step S51 of FIG. 12A (i.e., “reliable multi-destination delivery” in step S51 of FIG. 12A) will be described. The “multi-destination delivery reliable for short data” in step S51 may be realized by combining the “not-necessarily reliable multi-destination delivery” and “reliable one-to-one communication” described above using FIGS. 4A through 7C. Alternatively, the “multi-destination delivery reliable for short data” in step S51 may be realized by multi-destination delivery using “barrier synchronization” described later using FIGS. 15 and 16. Further, as another alternative, the “multi-destination delivery reliable for short data” in step S51 may be realized by multi-destination delivery using “reduction to all nodes” realized by “a reduction apparatus” described later using FIGS. 17 through 19.

Next, the reception-side node waits for reception of the sets of communication data from the transmission-side nodes (step S52). When the reception-side node finishes receiving the sets of communication data from all the transmission-side nodes, the reception-side node finishes the “gather” operation.

In FIG. 12B, the transmission-side nodes receive the above-mentioned information that indicates disposition of sets of communication data in communication buffers, transmitted in step S51 from the reception-side node by the “multi-destination delivery reliable for short data”, by the same “multi-destination delivery reliable for short data” (in step S53). Next, the transmission-side nodes transmit the sets of communication data of themselves to the communication buffers, respectively, using the WRDMA function (in step S54). More specifically, the transmission-side nodes obtain the addresses of the corresponding communication buffers based on the “information that indicates in which parts (buffers) of the communication buffers the transmission-side nodes will store (write) the sets of communication data” indicated by the received information that indicates disposition of sets of communication data in communication buffers. Then, by designating the thus obtained corresponding addresses of the communication buffers, respectively, and carrying out the WRDMA, the transmission-side nodes may transmit the sets of communication data of themselves and store the sets of communication data of themselves in the disposition within the appropriate parts (buffers) of the communication buffers. Thus, the transmission-side nodes finish the “gather” operation.

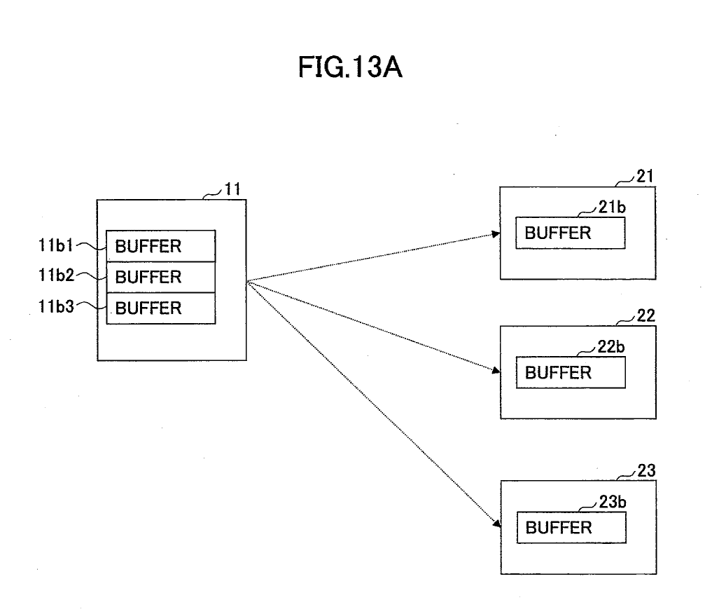

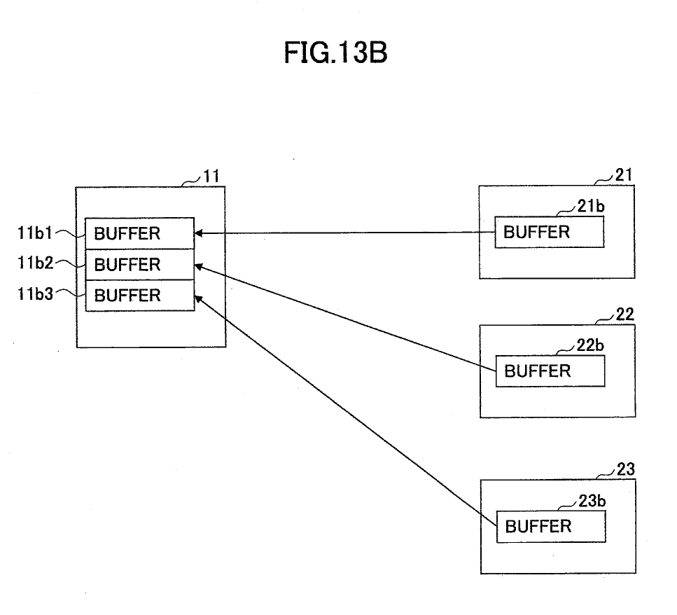

FIGS. 13A and 13B depict a specific example of the embodiment 2 described above using FIGS. 12A and 12B. In the first step depicted in FIG. 13A, the reception-side node 11 transmits the above-mentioned information that indicates disposition of sets of communication data in communication buffers to transmission-side nodes 21, 22 and 23, by the above-mentioned “multi-destination delivery reliable for short data”. Since this transmission is made by the multi-destination delivery, the common information that indicates disposition of sets of communication data in communication buffers is reported to the transmission-side nodes 21, 22 and 23. The transmission-side nodes 21, 22 and 23 receive the information that indicates disposition of sets of communication data in communication buffers, and may recognize from the received information the parts (buffers) of the communication buffers in which the sets of communication of themselves are to be stored, according to a predetermined rule.

Instead of using the “multi-destination delivery reliable for short data”, the collective communication method (“scatter”) according to the embodiment 1 described above may be used for transmitting the information that indicates disposition of sets of communication data in communication buffers to the transmission-side nodes 21, 22 and 23. In a case where the collective communication method according to the embodiment 1 is applied, the reception-side node 11 may transmit only information of corresponding buffers 11b1, 11b2 and 11b3 to the transmission-side nodes 21, 22 and 23, respectively. That is, the reception-side node 11 may transmit information of the buffer 11b1 to the node 21, transmit information of the buffer 11b2 to the node 22, and transmit information of the buffer 11b3 to the node 23.

In the second step depicted in FIG. 13B, the nodes (transmission-side nodes) 21, 22 and 23 other than the reception-side node 11 transmit the sets of communication data from buffers 21b, 22b and 23b of themselves using the WRDMA function, respectively. The sets of communication data thus transmitted from the transmission-side nodes 21, 22 and 23 are stored (written) in a disposition within the buffers 11b1, 11b2 and 11b3 of the reception-side node 11, respectively. This point will now be described in more detail. That is, the transmission-side nodes 21, 22 and 23 may recognize the buffers (from among the buffers 11b1, 11b2 and 11b3 of the reception-side node 11) in which the sets of communication data of themselves will be stored in disposition, respectively, based on the received information that indicates disposition of sets of communication data in communication buffers. Then, the transmission-side nodes 21, 22 and 23 designate the corresponding buffers 11b1, 11b2 and 11b3, respectively, and carry out the WRDMA. As a result, the transmission-side nodes 21, 22 and 23 can store their sets of communication data in a disposition within the corresponding buffers 11b1, 11b2 and 11b3, respectively. Thus, the “gather” function may be realized.

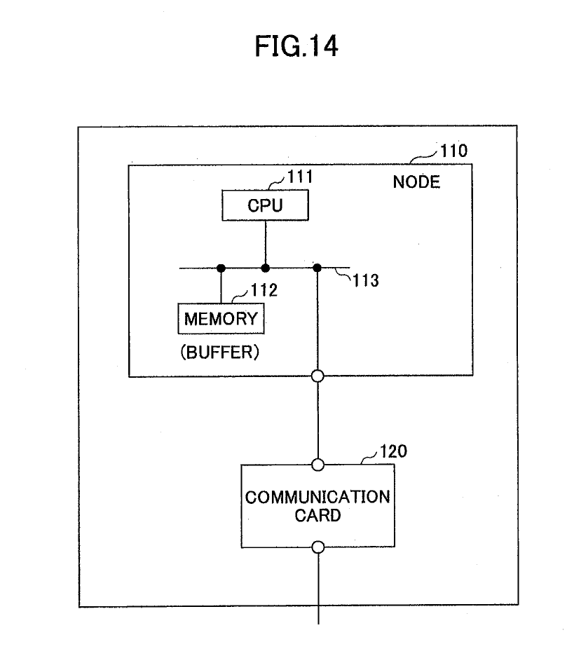

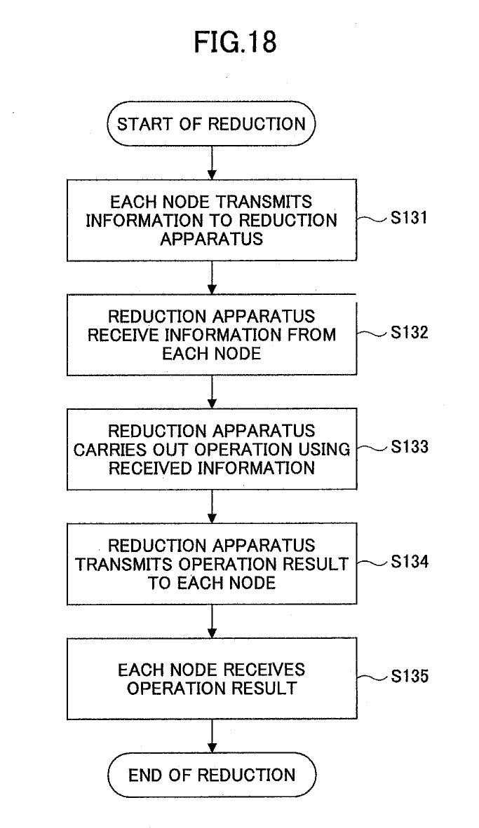

FIG. 14 illustrates a hardware configuration example of the nodes, i.e., the transmission-side nodes and the reception-side nodes mentioned above. Each node 110 includes a central processing unit (CPU) 111 and a memory 112, connected via a bus 113. The CPU may carry out various sorts of arithmetic and logic operations. In the memory 112, programs executed by the CPU 111 and various sorts of data are stored. The memory 112 may also be used as a communication buffer (mentioned above, to store or write communication data or transmission data transferred or to be transferred) used in the above-mentioned communication methods for parallel computing according to the embodiments 1 and 2. Further, in the memory 112, which may be formed by any suitable non-transitory computer readable recording medium, programs that realize the communication methods for parallel computing according to the embodiments 1 and 2 may be stored. The CPU 111 may carry out the operations described above using FIGS. 4A through 7C, FIGS. 9A through 13B, operations described later using FIGS. 15 and 16, and operations described later using FIGS. 17 and 18, by executing the programs. Further, the node 110 has a communication card (communication device) 120 to be used when the node 110 carries out communication with another node in the network. The communication card 120 is, for example, a NIC.

FIG. 15 is a flowchart illustrating a flow of operations of the above-mentioned “multi-destination delivery method reliable for short data” (in particular, in a case of using the “barrier synchronization”). In FIG. 15, in step S101, the transmission-side node (the reception-side node in the embodiment 2) stores the “information that indicates disposition of (sets of) communication data in communication buffers” in a certain storage location. Next, in step S102, all the nodes including the transmission-side node and the plurality of reception-side nodes (the reception-side node and the plurality of transmission-side nodes in the embodiment 2) carry out the “barrier synchronization” (to be described later using FIG. 16). Next, in step S103, the reception-side nodes (the transmission-side nodes in the embodiment 2) transfer the “information that indicates disposition of communication data in communication buffers” stored in the above-mentioned certain storage location to themselves, by the RRDMA function. As a result, the plurality of reception-side nodes (the plurality of transmission-side nodes in the embodiment 2) may obtain the “information that indicates disposition of communication data in communication buffers”.

In the method described above using FIG. 15, all the nodes synchronize with each other by the “barrier synchronization” in step S102. Then, after the synchronization, the reception-side nodes (the transmission-side nodes in the embodiment 2) obtain the “information that indicates disposition of communication data in communication buffers” from the certain storage location in step S103. Thus, the “multi-destination delivery method reliable for short data” method may be realized. In the previous step S101, the transmission-side node (the reception-side node in the embodiment 2) stores the “information that indicates disposition of communication data in communication buffers” in the certain storage location. Further, the information that indicates the certain storage location is previously shared by all the above-mentioned nodes, the transmission-side node (the reception-side node in the embodiment 2) stores the “information indicating that indicates communication data in communication buffers” in the certain storage location at a certain storage timing, and then, the transmission-side node (the reception-side node in the embodiment 2) releases the certain storage location at a certain release timing. The “barrier synchronization” is used as a measure to notify the reception-side nodes (the transmission-side nodes in the embodiment 2) of a time from the above-mentioned certain storage timing to the certain release timing, i.e., a time during which the “information that indicates disposition of communication data in communication buffers” exists in the above-mentioned certain storage location. The transmission-side node (the reception-side node in the embodiment 2) may obtain the above-mentioned certain release timing by carrying out the “barrier synchronization” again after step S103.

FIG. 16 is a flowchart depicting a flow of operations of “barrier synchronization” in step S102 of FIG. 15. In FIG. 16, in step S111, all the nodes mentioned above transmit the “barrier synchronization” signals to all the other nodes. It is sufficient that the “barrier synchronization” signals are the shortest signals only for the purpose of simply signaling a timing. In step S112, the nodes finish the operation when having received the “barrier synchronization” signals from all the other nodes (step S112 YES).

It is noted that, as to the “barrier synchronization”, “Concurrency: Mutual exclusion and synchronization” (URL: http://www.cs.helsinki.fi/u/alanko/rio/S02/kalvokopiot/ch3_p2.pdf (on May 14, 2009)), page 13, depicts diagrams from the viewpoint of “how to write a program”. Further, “Barrier Synchronization”, Maurice Herlihy & Nir Shavit (URL: http://www.cs.brown.edu/courses/cs176/ch17.ppt (on May 14, 2009)), pages 9 through 15, discusses a concept of “barrier synchronization”. In particular, in “Concurrency: Mutual exclusion and synchronization” (URL: http://www.cs.helsinki.fi/u/alanko/rio/S02/kalvokopiot/ch3_p2.pdf (on May 14, 2009)), the following point is described. That is, until all the threads (threads: individual processing flows in parallel processing) have passed through a certain processing block (in other words, until all the threads have reached a point immediately before the next processing), no thread proceeds to the next processing block.

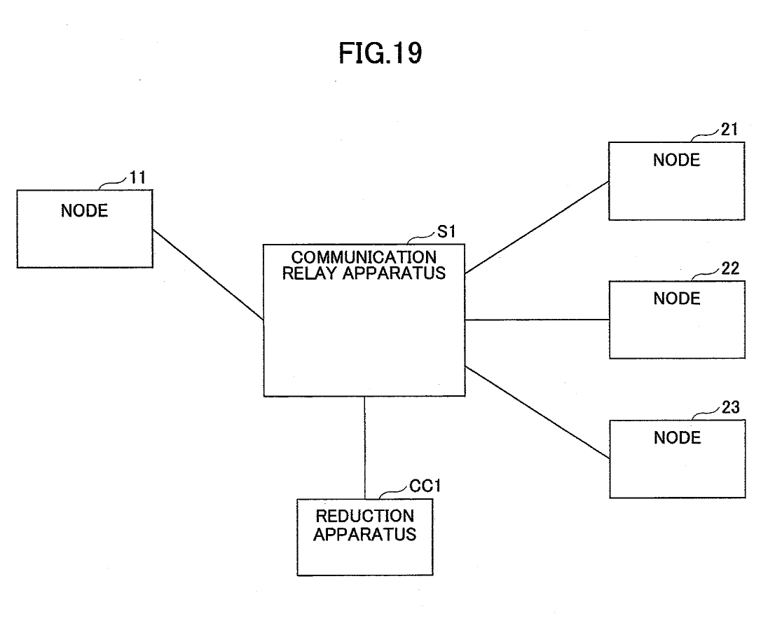

Using FIG. 17, a case will be described where the above-mentioned “reduction to all nodes” using the reduction apparatus is used as a measure to realize the above-mentioned “multi-destination delivery method reliable for short data”. The reduction apparatus will be described later using FIG. 19.

According to the “reduction to all nodes”, operation results obtained from operations such as summation, obtaining the maximum value or the like carried out on operation target data transmitted from all the nodes, are then received by all the nodes. In a case where the “reduction to all nodes” is carried out using the reduction apparatus, all the nodes transmit the operation target data to the reduction apparatus, and receive the operation results from the reduction apparatus. In a case where the “multi-destination delivery reliable for short data” is realized by the “reduction to all nodes” using the reduction apparatus, in step S121 (in step S120) of FIG. 17, the transmission-side node transmits the “information that indicates disposition of communication data in communication buffers” (simply referred to as “buffer information”, hereinafter) to the reduction apparatus. In step S122, the plurality of reception-side nodes transmit information “0” to the reduction apparatus. In step S123, after receiving the thus transmitted information, the reduction apparatus carries out a summation operation of the buffer information received in step S121 and the information “0” received in step S122. As a result of the summation operation, i.e., “buffer information”+“0”+“0”+“0”+ . . . =“buffer information”, the buffer information is thus obtained as an operation result. The reduction apparatus transmits the operation result to all the nodes. As a result, in step S124, the plurality of reception-side nodes can obtain the “buffer information” as the operation result. Thus, the “multi-destination delivery method reliable for short data” may be realized.

FIG. 18 is a flowchart illustrating the flow of operations of “multi-destination delivery method reliable for short data”, using the reduction apparatus. In FIG. 18, in step S131 (corresponding to steps S121, S122 in FIG. 17), the nodes transmit information to the reduction apparatus. In step S132 (corresponding to step S123), the reduction apparatus receives the information transmitted by the nodes. In step S133 (corresponding to step S123), the reduction apparatus carries out an operation (for example, the above-mentioned summation operation) based on the received information. In step S134 (corresponding to step S123), the reduction apparatus transmits the result of the above-mentioned operation to the nodes. In step S135 (corresponding to step S124), the nodes receive the result of the operation.

FIG. 19 is a block diagram illustrating the above-mentioned reduction apparatus (see FIGS. 16 and 17). The reduction apparatus CC1 is connected with the communication nodes 11, 21, 22 and 23 via a communication relay apparatus S1 in a network. The reduction apparatus CC1 may have a hardware configuration identical to that of the nodes described above using FIG. 14, for example. As mentioned above, the reduction apparatus CC1 receives information from all the nodes 11, 21, 22 and 23 (step S132 of FIG. 18), carries out a certain operation (for example, a summation operation, as mentioned above) (step S133 of FIG. 18), and transmits the result of the operation to all the nodes 11, 21, 22 and 23 (step S134 of FIG. 18).

“Development of High Function, High Performance System Interconnect Technology”, Kyushu University/Fujitsu Limited, Hiroaki Isihata (URL: http://www.psi-project.jp/images/event, “Development of High Performance Switch Supporting Collective Communication”, Fujitsu Limited, Shimizu Toshiyuki (URL: http://www.psi-project.jp/images/event/toshiyuki_shimizu_{—}20080218.pdf (on May 14, 2009)), and Fujitsu Forum 2008, “Advanced Technology Taking Role of Petascale Computing” (URL: http://forum.fujitsu.com/2008/tokyo/exhibition/downloads/pdf/technology02_panf_jp.pdf (on May 14, 2009)) discuss the reduction apparatus. It is noted that in “Development of High Function, High Performance System Interconnect Technology”, Kyushu University/Fujitsu Limited, Hiroaki Isihata (URL: http://www.psi-project.jp/images/event, and “Development of High Performance Switch Supporting Collective Communication”, Fujitsu Limited, Shimizu Toshiyuki (URL: http://www.psi-project.jp/images/event/toshiyuki_shimizu_{—}20080218.pdf (on May 14, 2009)), in a case where a term “collective communication” is used, actually it indicates only “reduction”, in many cases. However, operations of “MPI_Allreduce” that is a function for “reduction to all nodes” include an operation of “barrier synchronization” in a calculation process (for the purpose of calculating a value, “synchronization” processing is carried out consequently). Therefore, there is a case where “collective communication” indicates “reduction” and “barrier synchronization”. Fujitsu Forum 2008, “Advanced Technology Taking Role of Petascale Computing” (URL: http://forum.fujitsu.com/2008/tokyo/exhibition/downloads/pdf/technology02_panf_jp.pdf (on May 14, 2009)) discusses a role of a reduction apparatus in improving the speed of parallel computing. It is noted that a “high performance switch” realizes an operation of “MPI_Allreduce” that is a function for collective communication of MPI by hardware. By using “MPI_Allreduce”, it is possible to obtain a value, calculated from input data that all nodes have, for example, the sum, as an output of the function. Therefore, as a result of all the other nodes (than a node that transmits data) calling “MPI_Allreduce” while designating “0”, multi-destination delivery of the data is realized for “the data that has such a size that the data can be regarded as a numerical value”.

FIG. 20 illustrates an example of setting the above-mentioned “buffer”, “communication buffer”, “parts (buffers) of the communication buffers the sets of communication data are stored in disposition”, “parts (buffers) of the communication buffers the transmission-side nodes will store (write) the sets of communication data in disposition”, or the like.

In the case of the example of setting of FIG. 20, in the main storage 500 of a (communication) node, an area 520 having a starting address “521” is set as the “communication buffer” or “communication buffers” (or simply, the “buffer” or “buffers”). Further, in the buffer area 520, an area 525 having a length 523 starting from an address distant from the starting address 521 by an offset 522 is set as a part (buffer) of the “parts (buffers) of the communication buffers the sets of communication data are stored in disposition” or a part (buffer) of the “parts (buffers) of the communication buffers the transmission-side nodes will store (write) the sets of communication data in disposition”. That is, a part (buffer) of the “parts (buffers) of the communication buffers the sets of communication data are stored in disposition” or a part (buffer) of the “parts (buffers) of the communication buffers the transmission-side nodes will store (write) the sets of communication data in disposition” 525 has a range from the address obtained from “starting address 521”+“offset 522” to the address obtained from “starting address 521”+“offset 522”+“length 523”.

As mentioned above, according to the embodiment 1, the information that indicates disposition of communication data in communication buffers includes “messages indicating that the communication data is in disposition within the communication buffers” and “information indicating the disposition state of the communication data in the communication buffers. Further, the information indicating the disposition state of the communication data in the communication buffers indicates which parts (buffers) of the communication buffers in which the set of communication data provided for the reception-side nodes are stored in disposition. Therefore, in the example of setting of FIG. 20, the “information indicating which parts (buffers) of the communication buffers the sets of communication data provided for the reception-side nodes are stored in disposition” corresponds to the information that indicates the area 525. Thus, according to the embodiment 1, in the case of the example of setting of FIG. 20, the “information indicating which parts (buffers) of the communication buffers the sets of communication data provided for the reception-side nodes are stored in disposition” includes information related to the above-mentioned starting address 521, the offset 522 and the length 523. Therefore, according to the embodiment 1, “the information that indicates disposition of communication data in communication buffers” includes the information that indicates the area 525.

According to the embodiment 2, the “information that indicates disposition of communication data in communication buffers” includes the “information that indicates in which parts (buffers) of the communication buffers the transmission-side nodes will store (write) the sets of communication data in disposition”. Therefore, in the example of setting of FIG. 20, the “information that indicates in which parts (buffers) of the communication buffers the transmission-side nodes will store (write) the sets of communication data in disposition” corresponds to the information that indicates the area 525. Thus, according to the embodiment 2, in the case of the example of setting of FIG. 20, the “information that indicates in which parts (buffers) of the communication buffers the transmission-side nodes will store (write) the sets of communication data in disposition” includes information related to the above-mentioned starting address 521, the offset 522 and the length 523. Therefore, according to the embodiment 2, the “information that indicates disposition of sets of communication data in communication buffers” includes the information that indicates the area 525.

FIG. 21 illustrates an example of the data format of the above-mentioned recovery information. In the example illustrated in FIG. 21, the data format of the recovery information includes an area 310 storing an error detection code, an area 320 storing information indicating a size of data (transmission data or communication data), and an area 330 storing timeout period.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that various changes, substitutions, and alterations could be made hereto without departing from the spirit and scope of the invention.

1. A communication method for parallel computing, the communication method comprising:
reporting information that indicates disposition of communication data in a communication buffer by a first node to a plurality of second nodes by a multi-destination delivery using a barrier synchronization or a reduction to all nodes, the communication data being transferred between the first node and the plurality of second nodes by at least one of a plurality of collective communication methods as a node-to-node communication method used in parallel computing; and
transferring the communication data between the first node and the plurality of second nodes by the plurality of second nodes using the information that indicates the disposition of the communication data in the communication buffer.

2. The communication method as claimed in claim 1, wherein the transferring of the communication data between the nodes in at least one of the plurality of collective communication methods in parallel computing including scatter and gather is carried out using a method of directly writing a value in a memory of a remote host without intervention by a processor.

3. The communication method as claimed in claim 1, further comprising:
reporting the information that indicates the disposition of the communication data in the communication buffer between the nodes using a first communication relay apparatus of a first communication network; and
transferring the communication data between the nodes using a second communication relay apparatus of a second communication network that is different from the first communication network.

4. An information processing apparatus operable as a first node, the information processing apparatus comprising:
a processor to execute a procedure, the procedure including:
reporting information that indicates disposition of communication data in a communication buffer to a plurality of second nodes by a multi-destination delivery using a barrier synchronization or a reduction to all nodes, the communication data being transferred between the first node and the plurality of second nodes by at least one of a plurality of collective communication methods as a node-to-node communication method used in parallel computing including scatter and gather; and
determining a completion of the transfer of the communication data between the first node and the plurality of second nodes by the plurality of second nodes using the information that indicates the disposition of the communication data in the communication buffer.

5. The information processing apparatus as claimed in claim 4, further comprising:
a part configured to carry out the transfer of the communication data between the first node and the plurality of second nodes in the at least one of the plurality of collective communication methods in parallel computing including scatter and gather using a method of directly writing a value in a memory of a remote host without intervention by the processor.

6. The information processing apparatus as claimed in claim 4, wherein the processor further executes a procedure including:
reporting the information that indicates the disposition of the communication data in the communication buffer to the plurality of second nodes using a first communication relay apparatus of a first communication network; and
transferring the communication data between the first node and the plurality of second nodes using a second communication relay apparatus of a second communication network that is different from the first communication network.

7. A non-transitory computer readable recording medium storing a program which, when executed by a computer of a first node, causes the computer to perform a process, the process comprising:
reporting information that indicates disposition of communication data in a communication buffer to a plurality of second nodes by a multi-destination delivery using a barrier synchronization or a reduction to all nodes, the communication data being transferred between the first node and the plurality of second nodes by at least one of a plurality of collective communication methods used in parallel computing; and
determining a completion of the transfer of the communication data between the first node and the plurality of second nodes by the plurality of second nodes using the information that indicates the disposition of the communication data in the communication buffer.

8. The non-transitory computer readable recording medium as claimed in claim 7, wherein the transfer between the first node and the plurality of second nodes in the at least one of the plurality of collective communication methods in parallel computing including scatter and gather is carried out using a method of directly writing a value in a memory of a remote host without intervention by the computer.

9. The non-transitory computer readable recording medium as claimed in claim 7, wherein the process further comprises:
reporting the information that indicates the disposition of the communication data in the communication buffer to the plurality of second nodes using a first communication relay apparatus of a first communication network; and
transferring the communication data between the first node and the plurality of second nodes using a second communication relay apparatus of a second communication network that is different from the first communication network.
